(19) United States
(12) Patent Application Publication
(10) Pub. No.: US 2020/0250915 A1
(43) Pub. Date: Aug. 6, 2020

(54) METHODS AND SYSTEMS FOR DELIVERY STORAGE

(71) Applicant: Bolt Holdings, LLC, Timnath, CO (US)

(72) Inventors: Robert Schachte, Fort Collins, CO (US); Tyler Johansen, Fort Collins, CO (US); Andrew Mill, Timnath, CO (US)

(73) Assignee: Bolt Holdings, LLC, Timnath, CO (US)

(21) Appl. No.: 16/269,546

(22) Filed: Feb. 6, 2019

(51) Int. Cl. G07F 17/12; G06Q 10/08; B65G 1/04; G07C 9/00

(52) U.S. Cl. CPC G07F 17/12; G06Q 10/0836; G07C 2009/00095; G07C 9/00087; B65G 1/0485

(57) ABSTRACT

A delivery storage system including a receptacle having a compartment for receiving a delivery and a barrier configured to move between an opened position for access to the compartment and a closed position to block access to the compartment. A lock may be configured to lock the barrier in the closed position and configured to be unlocked to allow the barrier to move to the opened position. A controller may be configured to receive an unlock condition that is provided based on a software application used by a user, and configured to unlock the lock to allow the barrier to move to the opened position for allowing a deliverer to place the delivery in the compartment based on receipt of an unlock indicator, from the deliverer, that satisfies the unlock condition.

### BACKGROUND

Deliveries have become more ubiquitous in recent years. Improved offerings by online delivery services and advances in mobile computing have enhanced the ease by which individuals may request and receive deliveries. Deliveries may extend from parcels, to food deliveries, to prescription pharmaceuticals, and even to alcoholic beverages.

Such advances in delivery services, however, have not been met by adequate advances in the end-point or delivery point of the delivery. Commonly, deliveries are left on the front porch of a home, where others may easily steal the delivery. This may be a significant loss for the delivery recipient if valuable goods are left on the front porch of the home. In other situations, deliveries must be signed for by a delivery recipient, and if the recipient is not home, then the delivery will be either be returned or sent to a central processing area for the recipient to pick up at a later date. This can result in a significant time expenditure by the recipient.

In addition, for perishable deliveries, the recipient is often concerned about spoliation of the delivery. If the recipient is not home when the grocery delivery arrives, then the grocery delivery may be left out on the front porch for spoliation or may be returned to the grocery store. The delivery recipient may need to wait at home until a grocery delivery arrives, or risk the grocery delivery being spoiled or returned. This may take a significant amount of time for the recipient if a large delivery window is given by the grocery delivery service for possible delivery.

Further, for on-demand deliveries, the recipient may not be able to coordinate being at home at the correct time for the delivery. For example, for on-demand food deliveries, the recipient may place a request for a food delivery and then need to wait at home until the food delivery arrives, or else risk spoliation of the food delivery or having a hot food delivery get cold.

From the deliverers perspective, deliverers often are uncertain where to leave a delivery and what protocol to use to leave a delivery. Deliverers may spend a long period of time waiting at a door to see if a delivery recipient is home, or may be unsure whether to simply leave a delivery at the front door. Such a time expenditure can result in a significant loss for the deliverer, particularly if that deliverer has many other deliveries to make that day.

### SUMMARY

There is a need for improved methods, systems, and devices for delivery storage and other processing of deliveries. Embodiments disclosed herein may address the problems present with end-points or delivery points of deliveries. The embodiments disclosed herein may provide a secure delivery point for a delivery and may secure the delivery until a time that the user is ready to retrieve the delivery. The user may not need to be at home to receive a delivery and may not need to schedule being at home to receive a delivery.

Embodiments herein may include a delivery storage system including a receptacle for receiving a delivery. The receptacle may be configured to be secure, such that a delivery placed within the receptacle cannot be stolen from the receptacle by another individual. The receptacle may be configured to be placed in a location accessible by a deliverer, such as a user's front yard or the like, such that a deliverer may quickly find the receptacle and place the delivery within the receptacle. In addition, the user may automatically sign for, or provide authorization for receipt of a delivery through the systems disclosed herein. The receptacle may be configured to automatically notify the user that the delivery has been completed.

The receptacle may be configured to receive deliveries from multiple different delivery services. The receptacle may be configured to receive delivery from parcel delivery services such as the United States Postal Service (USPS) as well as on-demand delivery services, among others. Systems disclosed herein may integrate with delivery services such that a user may be able to request deliveries from multiple different delivery services.

The receptacle may be for personal use or household use, such that the receptacle is dedicated for use by the inhabitants of the delivery location. The receptacle may be placed on the property of the inhabitants of the delivery location and may be a free standing receptacle or may be joined with another structure of the delivery location, such as a garage or the like.

The receptacle may include one or more temperature controlled compartments, such that a perishable food delivery may be stored and refrigerated or frozen until the user desires to retrieve the delivery. As such, a user may place a grocery delivery request at work and not have to worry about missing a delivery window or the delivery spoiling.

The embodiments disclosed herein may include software methods for automatically providing unlock conditions for unlocking the receptacle for a deliverer. Thus, a deliverer may be automatically provided with a means to unlock the receptacle and rapidly place the delivery within the receptacle. In some embodiments, the software methods disclosed herein may automatically retrieve parcel tracking numbers or codes, such that a deliverer may merely need to scan such a parcel tracking number or code at the receptacle to unlock the receptacle.

The embodiments disclosed herein may be configured to automatically enroll the user with multiple delivery services that may provide deliveries to the receptacle.

The embodiments disclosed herein may provide a manner for users to transfer items with others, for pick up at the receptacle.

The embodiments disclosed herein may beneficially allow a user to enhance the means by which the user receives deliveries and may enhance the means by which the user may transfer items to other individuals. In addition, the user beneficially has reduced concern that a delivery may be stolen from the user's property. Further, with a temperature controlled compartment, the user has reduced concern regarding perishable foods undergoing spoliation before the user picks up the delivery.

Embodiments disclosed herein may include a delivery storage system. The delivery storage system may include a receptacle including a compartment for receiving a delivery and a barrier configured to move between an opened position for access to the compartment and a closed position to block access to the compartment. The system may include a lock configured to lock the barrier in the closed position and configured to be unlocked to allow the barrier to move to the opened position. The system may include a controller configured to receive an unlock condition that is provided based on a software application used by a user, and configured to unlock the lock to allow the barrier to move to the opened position for allowing a deliverer to place the delivery in the compartment based on receipt of an unlock indicator, from the deliverer, that satisfies the unlock condition.

Embodiments disclosed herein may include a method. The method may include providing a receptacle on a residential property, the receptacle including a compartment for receiving a delivery and a barrier configured to move between an opened position for access to the compartment and a closed position to block access to the compartment. The method may include providing a lock configured to lock the barrier in the closed position and configured to be unlocked to allow the barrier to move to the opened position. The method may include providing a controller configured to receive an unlock condition that is provided based on a software application used by a user, and configured to unlock the lock to allow the barrier to move to the opened position for allowing a deliverer to place the delivery in the compartment based on receipt of an unlock indicator, from the deliverer, that satisfies the unlock condition.

Embodiments disclosed herein may include a method. The method may include determining an unlock condition for a receptacle that is to receive a delivery for a user, the receptacle including a compartment for receiving the delivery and a barrier configured to move between an opened position for access to the compartment and a closed position to block access to the compartment and a lock configured to lock the barrier in the closed position and configured to be unlocked to allow the barrier to move to the opened position. The method may include providing the unlock condition to a controller of the receptacle, the controller configured to unlock the lock to allow the barrier to move to the opened position for allowing a deliverer to place the delivery in the compartment based on receipt of an unlock indicator, from the deliverer, that satisfies the unlock condition.

Embodiments disclosed herein may include a system including a server. The server may be configured to determine an unlock condition for a receptacle that is to receive a delivery for a user, the receptacle including a compartment for receiving the delivery and a barrier configured to move between an opened position for access to the compartment and a closed position to block access to the compartment and a lock configured to lock the barrier in the closed position and configured to be unlocked to allow the barrier to move to the opened position. The server may be configured to provide the unlock condition to a controller of the receptacle, the controller configured to unlock the lock to allow the barrier to move to the opened position for allowing a deliverer to place the delivery in the compartment based on receipt of an unlock indicator, from the deliverer, that satisfies the unlock condition.

Embodiments disclosed herein may include a delivery storage system. The delivery storage system may include a receptacle including a compartment for receiving a delivery and a barrier configured to move between an opened position for access to the compartment and a closed position to block access to the compartment. The delivery storage system may include a lock configured to lock the barrier in the closed position and configured to be unlocked to allow the barrier to move to the opened position. The delivery storage system may include a controller configured to have an unlock condition that is satisfied by an unlock indicator that is provided to a deliverer, the controller configured to unlock the lock to allow the barrier to move to the opened position for allowing the deliverer to place the delivery in the compartment based on receipt of the unlock indicator from the deliverer.

Embodiments disclosed herein may include a method. The method may include providing an unlock indicator to a deliverer based on a delivery requested by a user with a software application, the unlock indicator configured to satisfy an unlock condition of a controller of a receptacle that is to receive a delivery for a user, the receptacle including a compartment for receiving the delivery and a barrier configured to move between an opened position for access to the compartment and a closed position to block access to the compartment and a lock configured to lock the barrier in the closed position and configured to be unlocked to allow the barrier to move to the opened position, and the controller configured to unlock the lock to allow the barrier to move to the opened position for allowing the deliverer to place the delivery in the compartment based on receipt of the unlock indicator from the deliverer.

Embodiments disclosed herein may include a method. The method may include providing a receptacle on a residential property, the receptacle including a compartment for receiving a delivery and a barrier configured to move between an opened position for access to the compartment and a closed position to block access to the compartment. The method may include providing a lock configured to lock the barrier in the closed position and configured to be unlocked to allow the barrier to move to the opened position. The method may include providing a controller configured to have an unlock condition that is satisfied by an unlock indicator that is provided to a deliverer, the controller configured to unlock the lock to allow the barrier to move to the opened position for allowing the deliverer to place the delivery in the compartment based on receipt of the unlock indicator from the deliverer.

Embodiments disclosed herein may include a system including a server. The server may be configured to provide an unlock indicator to a deliverer based on a delivery requested by a user with a software application, the unlock indicator configured to satisfy an unlock condition of a controller of a receptacle that is to receive a delivery for a user, the receptacle including a compartment for receiving the delivery and a barrier configured to move between an opened position for access to the compartment and a closed position to block access to the compartment and a lock configured to lock the barrier in the closed position and configured to be unlocked to allow the barrier to move to the opened position, and the controller configured to unlock the lock to allow the barrier to move to the opened position for allowing the deliverer to place the delivery in the compartment based on receipt of the unlock indicator from the deliverer.

### BRIEF DESCRIPTION OF THE DRAWINGS

Features and advantages of the systems, apparatuses, and methods as disclosed herein will become appreciated as the same become better understood with reference to the specification, claims, and appended drawings wherein:

FIG. 1 illustrates a schematic view of a system, according to an embodiment of the present disclosure.

FIG. 2 illustrates a side perspective view of a receptacle, according to an embodiment of the present disclosure.

FIG. 3 illustrates a side perspective view of the receptacle of FIG. 2 with an open compartment, according to an embodiment of the present disclosure.

FIG. 4 illustrates a side perspective view of a section of the receptacle of FIG. 1, according to an embodiment of the present disclosure.

FIG. 5 illustrates a top cut away view of the receptacle of FIG. 1 with an open compartment, according to an embodiment of the present disclosure.

FIG. 6 illustrates a side perspective view of a section of the receptacle of FIG. 1, according to an embodiment of the present disclosure.

FIG. 7 illustrates a side perspective view of a section of the receptacle of FIG. 1 without containers present, according to an embodiment of the present disclosure.

FIG. 8 illustrates a side perspective view of a top section of the receptacle of FIG. 1, according to an embodiment of the present disclosure.

FIG. 9 illustrates a side perspective view of a top section of the receptacle of FIG. 1 without containers present, according to an embodiment of the present disclosure.

FIG. 10 illustrates a top cut away view of a top section of the receptacle of FIG. 1, according to an embodiment of the present disclosure.

FIG. 11 illustrates a side perspective view of the receptacle of FIG. 1, according to an embodiment of the present disclosure.

FIG. 12 illustrates a schematic view of components of a system, according to an embodiment of the present disclosure.

FIG. 13 illustrates a top perspective view of a receptacle within a garage, according to an embodiment of the present disclosure.

FIG. 14 illustrates perspective views of the receptacle of FIG. 13 and another receptacle, according to an embodiment of the present disclosure.

FIG. 15 illustrates a side perspective view of a compartment, according to an embodiment of the present disclosure.

FIG. 16 illustrates a side perspective view of a compartment, according to an embodiment of the present disclosure.

FIG. 17 illustrates steps of a method according to an embodiment of the present disclosure.

FIG. 18 illustrates a screen of a software application on a mobile communication device, according to an embodiment of the present disclosure.

FIG. 19 illustrates a screen of a software application on a mobile communication device, according to an embodiment of the present disclosure.

FIG. 20 illustrates screens of a software application on a mobile communication device, according to an embodiment of the present disclosure.

FIG. 21 illustrates screens of a software application on a mobile communication device, according to an embodiment of the present disclosure.

FIG. 22 illustrates screens of a software application on a mobile communication device, according to an embodiment of the present disclosure.

FIG. 23 illustrates a screen of a software application on a mobile communication device, according to an embodiment of the present disclosure.

FIG. 24 illustrates a screen visible to a deliverer, according to an embodiment of the present disclosure.

FIG. 25 illustrates a screen visible to a deliverer, according to an embodiment of the present disclosure.

FIG. 26 illustrates screens of a software application on a mobile communication device, according to an embodiment of the present disclosure.

FIG. 27 illustrates screens of a software application on a mobile communication device, according to an embodiment of the present disclosure.

FIG. 28 illustrates a screen of a software application on a mobile communication device, according to an embodiment of the present disclosure.

FIG. 29 illustrates a screen visible to a delivery service, according to an embodiment of the present disclosure.

FIG. 30 illustrates a screen visible to a delivery service, according to an embodiment of the present disclosure.

FIG. 31 illustrates screens visible to a deliverer, according to an embodiment of the present disclosure.

FIG. 32 illustrates screens visible to a deliverer, according to an embodiment of the present disclosure.

### DETAILED DESCRIPTION

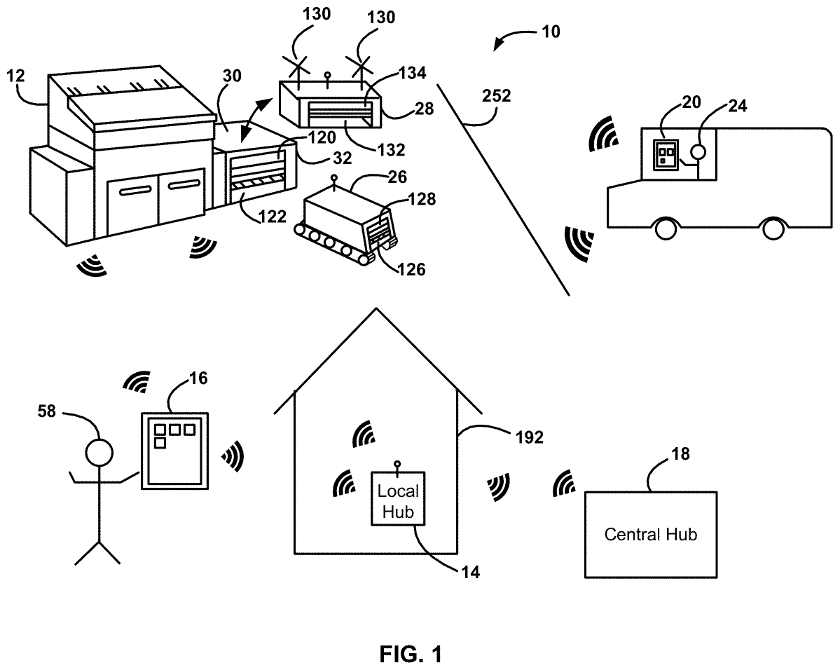

FIG. 1 illustrates components that may be utilized in a delivery storage system 10 according to an embodiment of the present disclosure. The components may include a receptacle 12, a local hub 14, a mobile communication device 16, a central hub 18, and a mobile communication device 22 of a deliverer 24. In the embodiment shown in FIG. 1, the system may include a mobile robot 26 and a delivery drone 28.

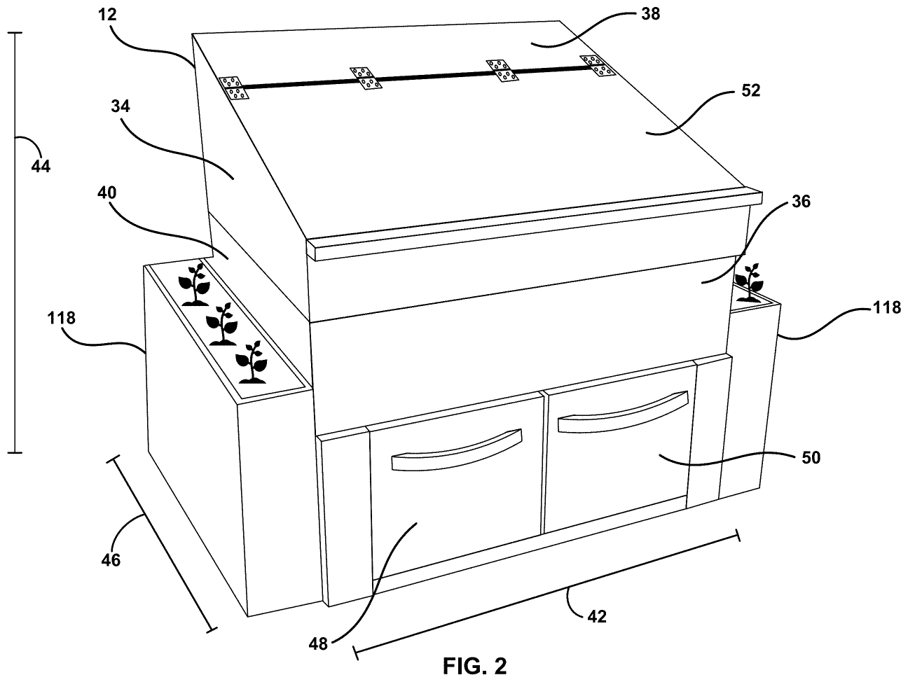

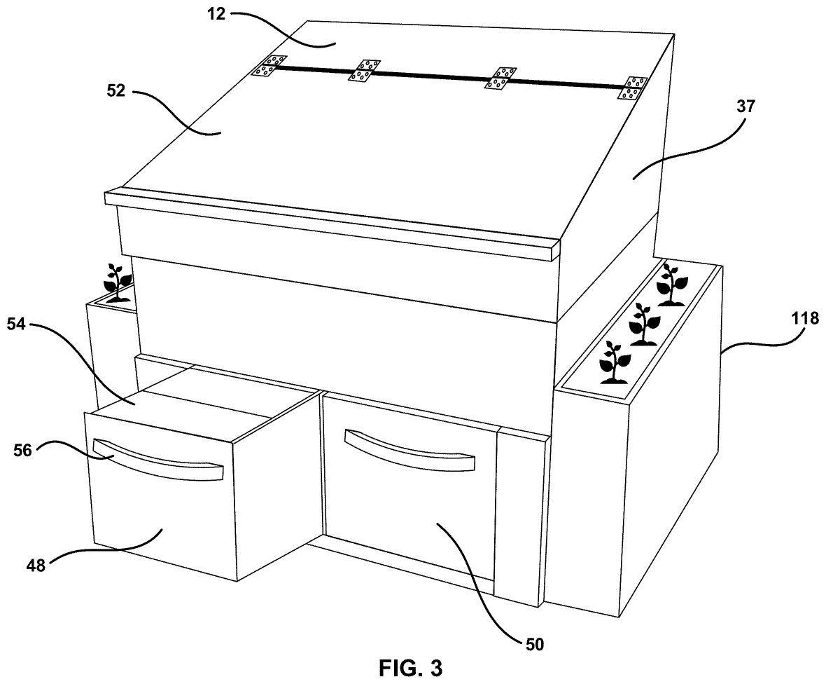

The components may be utilized to operate the delivery storage system 10 such that the receptacle 12 may receive and store a delivery of a deliverer 24. FIG. 2 illustrates a side perspective view of a receptacle 12 for use with the system 10. The receptacle 12 is shown in FIG. 2 without a drone landing pad 30 and a mobile robot receptacle 32 shown in FIG. 1. The receptacle 12 may include a plurality of walls 34, 36, 38 that form an outer surface 40 of the receptacle 12. The walls may include a plurality of side walls 34, 36, 37 (the right side wall 37 is shown in FIG. 3 and the rear side wall is not visible in FIG. 2) and a top wall 38. A bottom wall may be included to enclose the interior of the receptacle 12. The side walls 34, 36, 37 may form side surfaces of the receptacle 12 and the top wall 38 may form a top surface of the receptacle 12. The receptacle 12 may include four side walls 34, 36, 37 (the rear side wall is not visible in FIG. 2) and one top wall 38, although in other embodiments a greater or lesser number of side walls may be utilized. For example, in one embodiment, the receptacle 12 may have a triangular, pentagonal, hexagonal, or other shape (e.g., circular, octagonal) as desired.

The receptacle 12 may be shaped as a box, as shown in FIG. 2. The receptacle as shown in FIG. 2 has a width 42, a height 44, and a depth 46. The receptacle 12 may be configured to be free standing, as shown in FIG. 2, such that the receptacle 12 may be placed in position without other supporting structures. A lower base of the receptacle 12 may be configured to be positioned on the ground or other lower supporting surface. The receptacle 12 may be configured such that the outer surfaces on each side of the receptacle are exposed to the outdoors, as well as the top surface of the receptacle. In other embodiments, the receptacle 12 may be joined with another structure. For example, one or more sides of the receptacle 12 may be joined with a wall or other structure.

The outer surface 40 of the receptacle 12 may be configured to be durable, to withstand exposure to the outdoors. The outer surface 40 may be made of a material that withstands weathering and exposure to temperature variations that may occur outdoors (in both hot climates and cold climates). The outer surface 40 may be configured to be decorative, to blend in with the surroundings or provide a pleasant appearance to the user. For example, the outer surface 40 may be configured to match the appearance of a house or other nearby structure. All or a portion of the receptacle 12 may be configured to be air-sealed, such that air cannot pass to or from the receptacle 12, particularly from compartments of the receptacle that may be temperature controlled or may be configured to be air-sealed. The receptacle 12 may be configured to resist an individual breaking and entering the receptacle 12, and may be configured to secure contents of the compartments from access by such an individual. The receptacle 12 may be configured to be fixed in position such that an individual cannot remove the receptacle 12 from its position and potentially steal the receptacle 12. The receptacle 12 may be constructed with an angle iron frame, to provide support and security for the receptacle 12.

The receptacle 12 may be configured to be installed in position on a location. The receptacle 12 may be configured to be constructed in position by an installer or other individual, or may be delivered for placement in position. The receptacle 12 may be installed such that the receptacle 12 is fixed in position. The receptacle 12 may be installed or otherwise provided in a location that is accessible by a deliverer 24. The receptacle 12 may be installed on a property such as a residential, commercial, industrial, or other type of property, and may be installed at a location on the property that is accessible by a deliverer 24 without the deliverer 24 breaking into a home or the like. Such a location may include a lawn, a patio, an outdoor walkway, parking lot, sidewalk, delivery bay, or a porch of the property. Such locations may be those customarily accessible by a deliverer and may be publicly accessible. The receptacle 12 may be positioned in a location such that the receptacle 12 is easily visible and accessible by the deliverer 24, such as a front lawn or the like. The receptacle 12 may be installed outdoors.

The receptacle 12 may be positioned on a residential property such as a single family home property. The receptacle 12 may be for use by one or more members of a household of the single family home property. The one or more members may use the receptacle 12 to receive deliveries and store the deliveries until retrieved by one of the members of the household. The receptacle 12 may be dedicated for such use by the one or more of the members of the household. The receptacle 12 may be the property of the one or more members of the household. In one embodiment, the receptacle 12 may be positioned on another form of residential property. For example, the receptacle 12 may be positioned in an apartment community, or other form of community housing. The receptacle 12 may be configured for use by an inhabitant of the housing community, or certain compartments of the receptacle 12 may be dedicated for use by certain inhabitants of the housing community. In other embodiments, the receptacle 12 may be positioned on other forms of property such as commercial property, and may be for use by the business or businesses, or individuals, of the commercial property.

The receptacle 12 may include one or more compartments for receiving a delivery. The compartments may be positioned within the receptacle 12. The receptacle 12 may include one or more barriers 48, 50, 52 that are configured to move between an opened position for access to a compartment and a closed position to block access to the compartment. As shown in FIG. 2, the receptacle includes three barriers 48, 50, 52, one barrier comprising a top door 52 configured to pivot to move to the opened position, and two barriers 48, 50 each comprising a drawer face configured to slide to move to the opened position. In other embodiments, the barriers 48, 50, 52 may have a variety of forms, including a door, a gate, a drawer face, or other form of barrier. The barriers 48, 50, 52 may be configured to move in various manners to move to the opened position.

FIG. 3 illustrates the barrier 48 in an opened position. The barrier 48 has slid forward such that a compartment 54 is accessible by a deliverer 24 to place a delivery within the compartment 54. The barrier 48 may include a handle 56 for a deliverer 24 (or a user 58 of the receptacle marked in FIG. 1) to grasp to pull the barrier 48 forward and open the compartment 54.

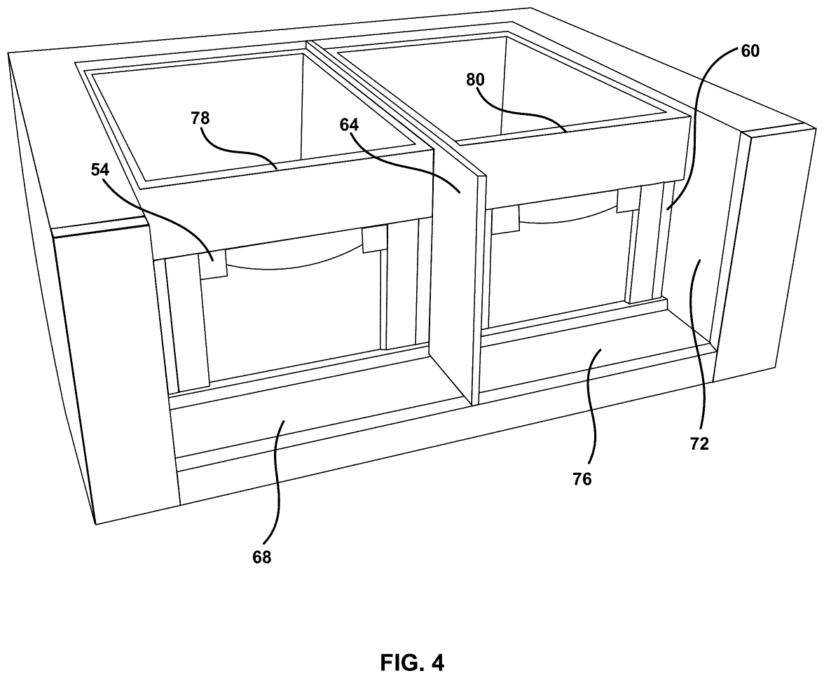

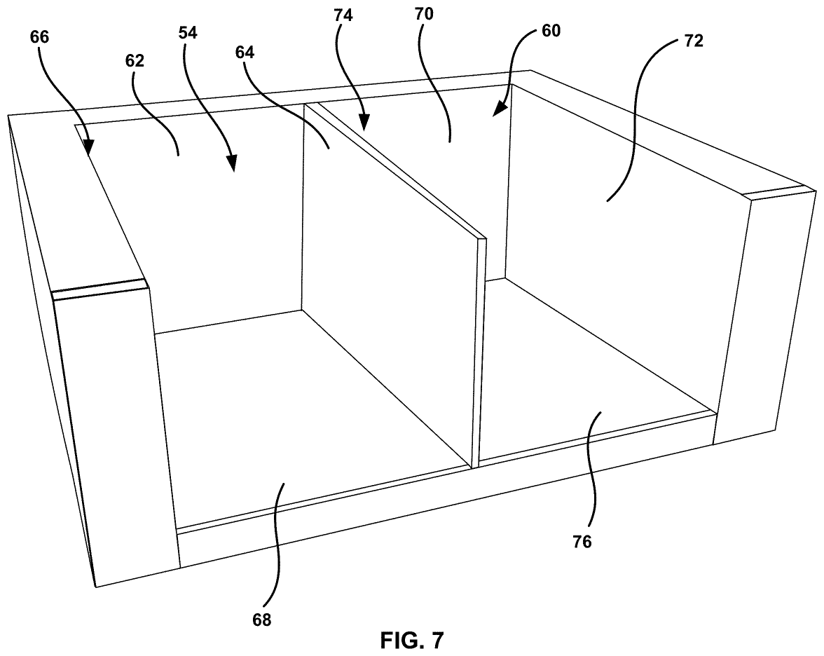

FIG. 4 illustrates a side perspective view of a section of the receptacle showing the compartments 54, 60. The barriers 48, 50 are not shown. The compartments 54, 60 may each be configured to receive a delivery. The compartments 54, 60 may each include a plurality of walls 62, 64, 66, 68, 70, 72, 74, 76 (marked in FIG. 7) that form respective sides (walls 62, 64, 66, 70, 72, 74) and bottoms (walls 68, 76) of the compartments 54, 60. The walls 62, 64, 66, 68, 70, 72, 74, 76 may be configured to resist an individual breaking and entering the respective compartment 54, 60, and may be configured to form an air-seal of the compartment 54, 60 if desired. For example, one of the compartments 54, 60 may be a temperature controlled compartment, and may have an air-seal to avoid cooled or heated air from escaping from the compartment 54, 60.

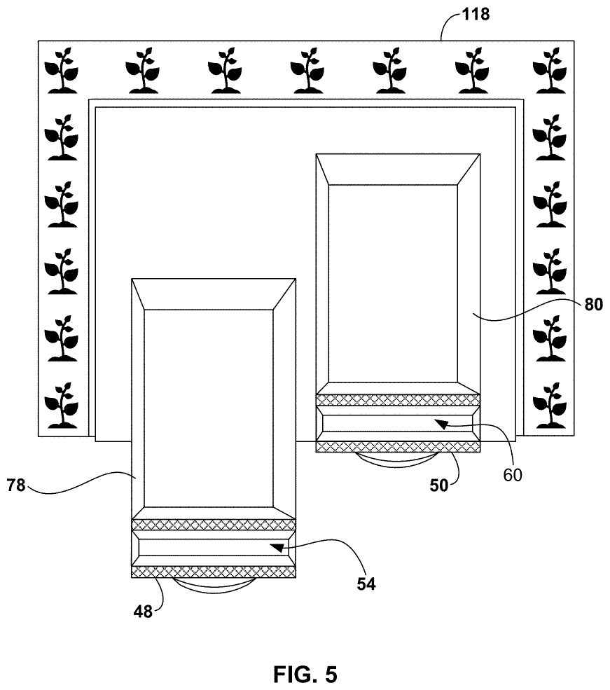

As shown in FIGS. 4 and 7, the walls 62, 64, 66, 68, 70, 72, 74, 76 may form a rectangular shape for the respective compartment 54, 60, although other shapes may be used as desired. The respective compartments 54, 60 may each have a height, a width, and a depth. As represented in FIGS. 3 and 5, the compartments 54, 60 may be configured to slide outward from the receptacle 12.

The compartments 54, 60 may be configured such that each barrier 48, 50 controls access to the respective compartment 54, 60. For example, if barrier 48 is in the opened configuration, then the other compartments 60 of the receptacle 12 may remain inaccessible to a deliverer 24. The compartments 54, 60 accordingly may be separated from each other by the walls 62, 64, 66, 68, 70, 72, 74, 76 of the compartments 54, 60 or another structure.

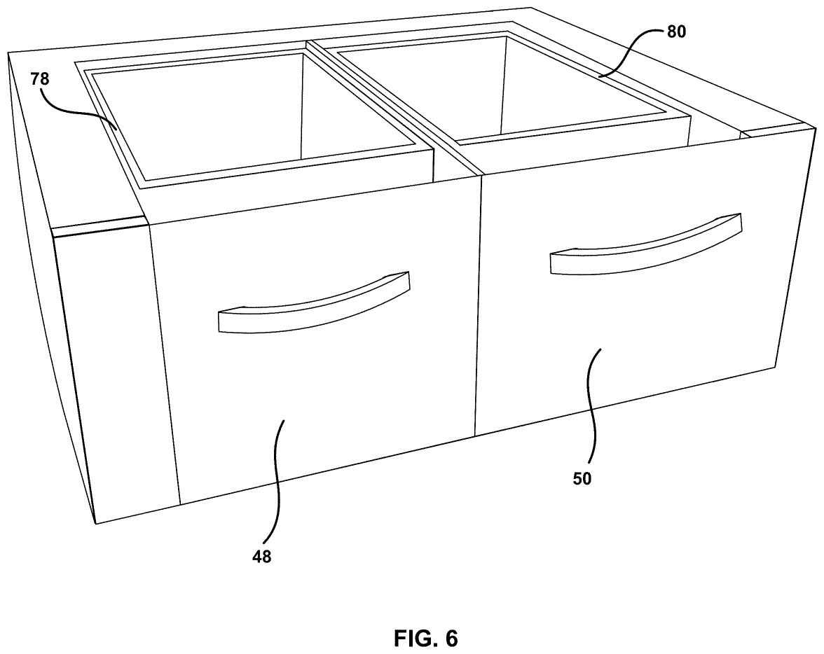

The compartments 54, 60 may be configured to receive a respective container 78, 80 that may be placed in the compartment 54, 60. The container 78, 80 may be provided by the deliverer 24, or may be pre-positioned in the compartment 54, 60 or provided by the user 58. In one embodiment, the containers 78, 80 may have a standard size that may be used across multiple different receptacles 12 of the system. FIG. 5 illustrates a top cut away view of the compartments 54, 60 including the containers 78, 80 positioned therein. FIG. 6 illustrates a side perspective view of the compartments 54, 60 including the containers 78, 80 positioned therein (and the barriers 48, 50 shown). FIG. 7 illustrates a side perspective view of the compartments 54, 60 without the containers 78, 80. The barriers 48, 50 are not shown.

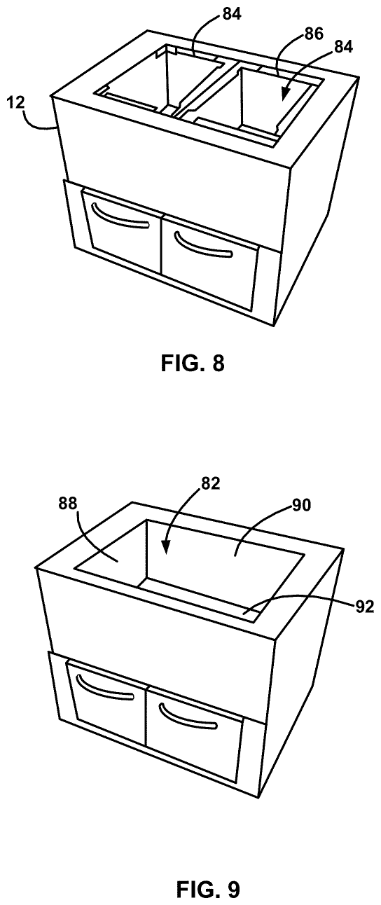

FIG. 8 illustrates a side perspective view of a section of the receptacle 12 showing a top compartment 82. The top compartment 82 may be enclosed by the barrier 52 on the top surface (shown in FIG. 2, in the form of a door). The top compartment 82 may be sized larger than the compartments 54, 60, and may be configured to hold two containers 84, 86. The compartment 82 may otherwise be configured similarly as the compartments 54, 60, with walls 88, 90, 92 marked in FIG. 9 (two other walls are not visible in FIG. 9) of the compartment 82 forming a length, width, and depth of the compartment 82. The compartment 82 may be positioned above the compartments 54, 60. FIG. 9 illustrates a side perspective view of the compartment 82 without the containers 84, 86 positioned therein.

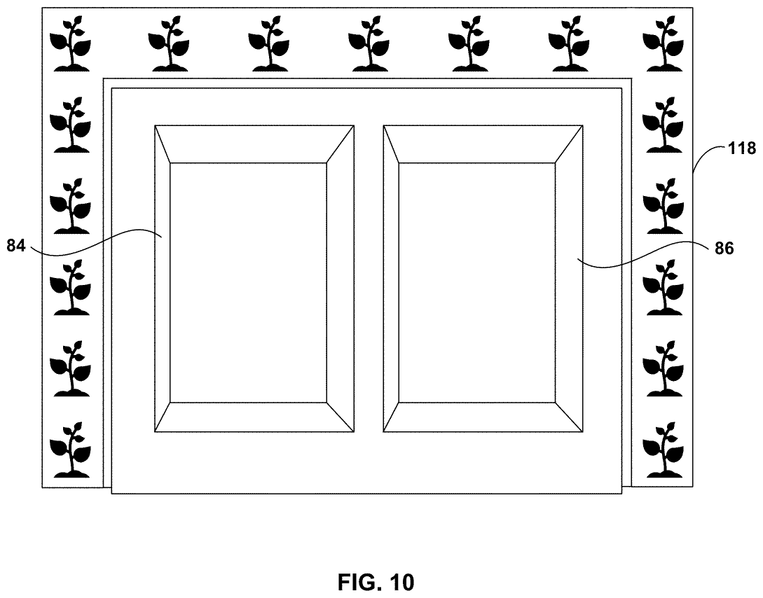

FIG. 10 illustrates a top cut away view of the compartment 82 including the containers 84, 86 positioned therein.

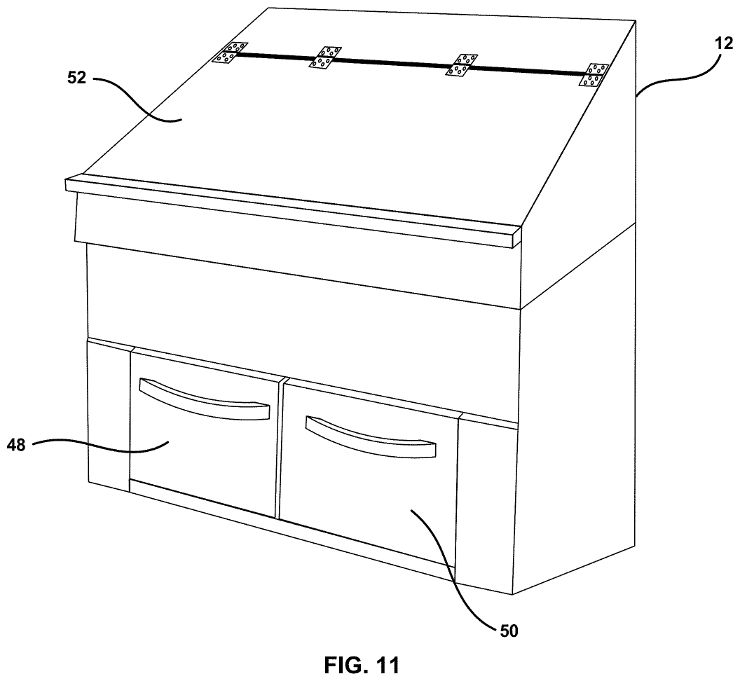

FIG. 11 illustrates a side perspective view of the receptacle 12. The receptacle may include any number of compartments 54, 60, 82 as desired. The receptacle may include three compartments 54, 60, 82 as represented in FIGS. 2-11, or may include one or more compartments. Access to each compartment 54, 60, 82 may be individually controlled by a respective barrier 48, 50, 52.

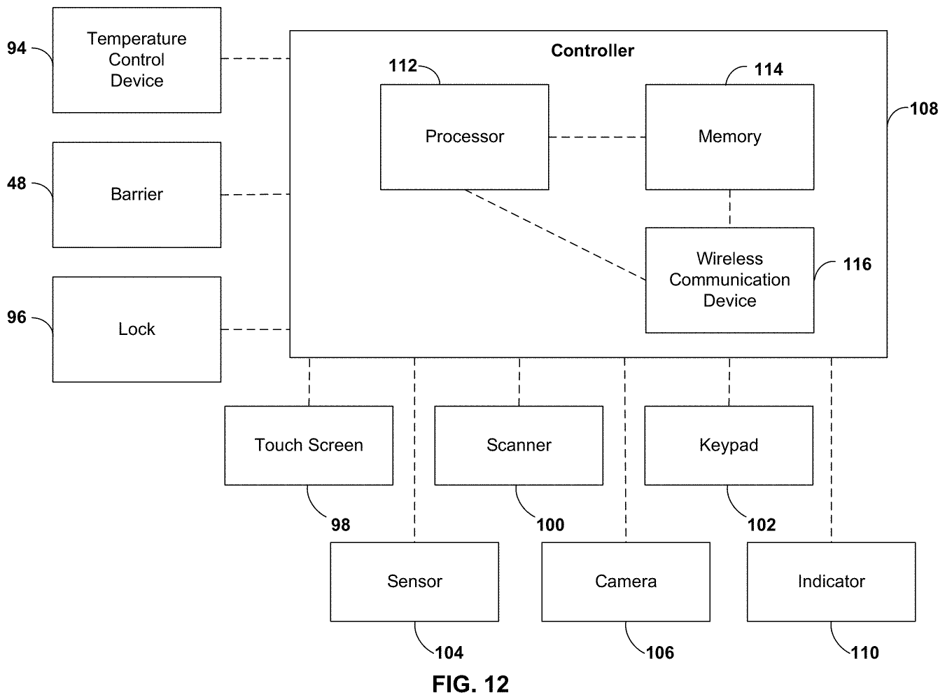

The compartments 54, 60, 82 may all be configured similarly, or one or more of the compartments 54, 60, 82 may be configured differently than other compartments 54, 60, 82. For example, one compartment 54, 60, 82 may be configured for parcel delivery, and one compartment 54, 60, 82 may be configured to receive a perishable delivery. One of the compartments 54, 60, 82 may be a temperature controlled compartment. For example, a temperature control device 94 (marked in FIG. 12) may be a part of the receptacle 12 and may be configured to control a temperature of one or more of the compartments 54, 60, 82 by raising or lowering a temperature of the respective compartment. The temperature control device 94 may be configured to refrigerate, freeze, heat, or otherwise set or vary a temperature of a compartment 54, 60, 82. The temperature control device 94 may comprise a refrigerator and/or freezer device (such as a compressor or the like) and/or may comprise a heater. A compartment 54, 60, 82 that is thermally controlled by the temperature control device 94 may be insulated to prevent heat transfer in or out of the compartment 54, 60, 82. A thermally controlled compartment 54, 60, 82 may reduce spoliation of a perishable delivery (such as groceries or food products or the like). A heated compartment may keep warm or hot prepared food products (e.g., prepared food deliveries) warm until the user 58 retrieves such products from the receptacle 12.

FIG. 12 illustrates components that may be utilized to operate the receptacle 12. The components may include the barriers, which have been discussed previously, and the temperature control device 94, discussed previously. The barrier is represented by reference number 48, however the discussion of the barrier 48 may apply to the other barriers 50, 52 shown in FIG. 2. Multiple temperature control devices 94 may be utilized as well, and may be dedicated for use with a compartment. The components may include one or more locks 96. Each lock 96 may be configured to lock a barrier 48, 50, 52 in the closed position and may be configured to be unlocked to allow the barrier 48, 50, 52 to move to the opened position. Each lock 96 may be configured to be sturdy enough to secure the barrier 48, 50, 52 in the closed position. For example, the lock 96 may be a mechanical lock (such as a latch or other form of mechanical lock) or may be a magnetic lock (including electrically controlled electro-magnetic locks or other forms of magnetic locks). In one embodiment, the lock may comprise pistons, arms, or bars for locking the barrier in a closed position and unlocking to allow the barrier to open. Such a lock may be configured to automatically open the barrier 48, 50, 52 (such as by pneumatic actuation or the like). The lock 96 may be configured to be controlled wirelessly (e.g., a wi-fi enabled lock). Each barrier 48, 50, 52 may have one or more locks 96 to lock the barrier 48, 50, 52 in the closed position.

The components may include one or more input devices. The input devices may comprise one or more of a touch screen 98, a scanner 100, a keypad 102, a sensor 104, and/or a camera 106, among other forms of input devices. The input devices may be configured for a user 58 or a deliverer 24 to use to unlock one or more of the locks 96. The input devices may be configured for other input or operation to the receptacle 12. The touch screen 98 may be configured for a user 58 or deliverer 24 to touch to unlock one or more of the locks 96 or perform another operation of the receptacle 12. The receptacle 12 may alternatively or additionally have a display screen for view by a user 58 or deliverer 24. The scanner 100 may comprise multiple forms of scanners, such as a barcode scanner or other form of code or symbol scanner. The keypad 102 may be configured for a user 58 or deliverer 24 to press to unlock one or more of the locks 96 or perform another operation of the receptacle 12. The keypad 102 may be configured to receive a code to unlock one or more of the locks 96. The sensor 104 may comprise a fingerprint sensor, a proximity sensor, a radio-frequency identification (RFID) sensor, or other form of sensor. The sensor 104 may be configured for a user 58 or deliverer 24 to unlock one or more of the locks 96 or perform another operation of the receptacle 12. The camera 106 may comprise a digital camera or other form of camera. The camera 106 may be configured for facial recognition or another form of image capture to unlock one or more of the locks 96 or perform another operation of the receptacle 12.

The one or more input devices may be positioned on the receptacle 12. For example, the one or more input devices may be coupled to the receptacle 12 and may be positioned on one of the side surfaces of the like. In one embodiment, the one or more input devices may be positioned at a location nearby the receptacle 12 to be used by a user 58 or deliverer 24, among other locations. The one or more input devices may be configured to communicate with the controller 108.

In one embodiment the components may include an indicator 110. The indicator 110 may be configured to indicate a location of the receptacle 12. For example, the indicator 110 may comprise a visual indicator, such as a light (for example one or more light emitting diodes (LEDs)) or an auditory indicator such as a speaker. In an embodiment in which the indicator 110 is a light, the light may be configured to shine brightly enough to be visible to a deliverer 24 in the vicinity of the receptacle 12. For example, the light may shine brightly upward into the air such that a deliverer 24 driving a delivery vehicle may see the light from the street. In an embodiment in which the indicator 110 is a speaker, the speaker may provide a sound to indicate a location of the receptacle 12 to a deliverer 24 in the vicinity of the receptacle 12. The indicator 110 in one embodiment may comprise a combination of a visual indicator (e.g., light) and an auditory indicator (e.g., speaker). The indicator 110 may be configured to be operated by the controller 108.

The components may include the controller 108. The controller 108 may be configured to operate the functions of the receptacle 12. The controller as shown in FIG. 12 may include a processor 112, and a memory 114, and a wireless communication device 116, although in other embodiments, the controller 108 may have different forms. For example, in one embodiment the controller 108 may be positioned remote from the receptacle and in one embodiment the controller 108 may have distributed components. In one embodiment, the controller may comprise one or more of the other components of the system (such as the mobile communication device 16, the local hub 14, or the central hub 18) to the extent such components control the receptacle 12 or perform the operations of the controller. Other forms of controllers may be utilized as desired.

The processor 112 may comprise a central processing unit (CPU) or other forms or combinations of one or more processors. The processor may be configured to process instructions and data to operate the receptacle 12. The memory 114 may comprise one or more forms of memory, including but not limited to RAM, ROM, solid state memory, a hard disk, or other forms of memory. The memory 114 may be configured to store a software application for operation by the processor 112 to operate functions of the receptacle 12. For example, a software application may be loaded onto the memory 114 to operate the functions of the receptacle 12. The wireless communication device 116 may comprise a wi-fi device, a Bluetooth device, or other form of device for wireless communication. In one embodiment, the wireless communication device 116 may include a global positioning system (GPS) transmitter/receiver to provide a geographic location of the receptacle 12 to others and to receive an indication of a geographic location of others (such as deliverers). In other embodiments, the controller 108 may include a wired communication device. The controller 108 may be configured to communicate with the other components of the receptacle with a wired or wireless connection, and other components of the system 10 as a whole with the wireless communication device 116.

The controller 108 may be configured to have an unlock condition. The unlock condition may be stored in the memory 114 of the controller and may be provided to the controller 108, which may include wireless communication of the unlock condition to the controller 108 (for example, via the wireless communication device 116). The unlock condition may be pre-programmed into the memory 114 of the controller 108, or may be determined remotely and provided to the controller 108. The controller 108 may be configured to unlock the lock 96 to allow the barrier 48, 50, 52 to move to the opened position to allow a deliverer 24 to place a delivery in the compartment 54, 60, 82 based on receipt of an unlock indicator, from the deliverer 24, that satisfies the unlock condition. Methods for the controller 108 to have the unlock condition and receive the unlock indicator are disclosed herein.

Referring back to FIG. 2, the receptacle 12 may be configured to have modules added to the receptacle. The delivery storage system may be configured to be modular system in which modules may be added or subtracted from the system. For example, as shown in FIG. 2, the receptacle 12 may be configured to have a decorative or planter module 118 coupled to the outer surface 40 of the receptacle 12. The decorative module 118 may enhance the decorative appeal of the receptacle 12. As shown in FIG. 5, the decorative module 118 may extend around multiple sides of the receptacle 12, including a rear side. FIG. 11 illustrates the receptacle 12 without the decorative module. The system may be configured to be customized based on the user's preference, by adding or subtracting modules as desired. The modules may be decorative or provide another function for the system.

For example, referring to FIG. 1, a module may include the mobile robot receptacle 32. The mobile robot receptacle 32 may be coupled to the receptacle 12 and may be configured to receive a mobile robot 26 that may be used in the system 10. The mobile robot receptacle 32 may include a barrier 120 (shown as a sliding door in FIG. 1) and may include a compartment 122 for receiving the mobile robot 26. The mobile robot receptacle 32 may be configured similarly as, and operate similarly as, the receptacle 12, unless otherwise stated herein.

A module may include the drone landing pad 30 for the delivery drone 28. The drone landing pad 30 may be configured for the delivery drone 28 to land upon. The modules may be separate from the receptacle 12, or may be coupled to the receptacle 12 as shown in FIG. 1. The drone landing pad 30 may be separate from the mobile robot receptacle 32, or may be coupled to the mobile robot receptacle 32 as shown in FIG. 1.

The system may include the mobile robot 26. The mobile robot 26 may be configured to move to receive a delivery. The mobile robot 26 may include a conveying device 124, such as treads, wheels, legs, or other forms of devices for conveying. As shown in FIG. 1, the conveying device 124 comprises treads. The mobile robot 26 may include a compartment 126 for receiving a delivery and a barrier 128 configured to move between an opened position for access to the compartment 126 and a closed position to block access to the compartment 126. As shown in FIG. 1, the barrier 128 may comprise a sliding door, although in other embodiments other forms of barriers may be utilized. The mobile robot 26 may include similar other components as the receptacle 12, including a lock and a controller, and other components, and may operate similarly as the receptacle 12 unless stated otherwise. The mobile robot 26 may be configured to communicate wirelessly with the receptacle 12 or other component of the system, such as the local hub 14, the central hub 18, or the mobile communication device 16, among others.

The system may include the delivery drone 28. The delivery drone 28 may be configured to fly to receive a delivery. The delivery drone 28 may include a conveying device 130, such as propellers or jets or other forms of devices for conveying. As shown in FIG. 1, the conveying device 130 comprises propellers. The delivery drone 28 may include a compartment 132 for receiving a delivery and a barrier 134 configured to move between an opened position for access to the compartment 132 and a closed position to block access to the compartment 132. As shown in FIG. 1, the barrier 134 may comprise a sliding door, although in other embodiments other forms of barriers may be utilized. The delivery drone 28 may include similar other components as the receptacle 12, including a lock and a controller, and other components, and may operate similarly as the receptacle unless stated otherwise. The delivery drone 28 may be configured to communicate wirelessly with the receptacle 12 or other component of the system, such as the local hub 14, the central hub 18, or the mobile communication device 16, among others.

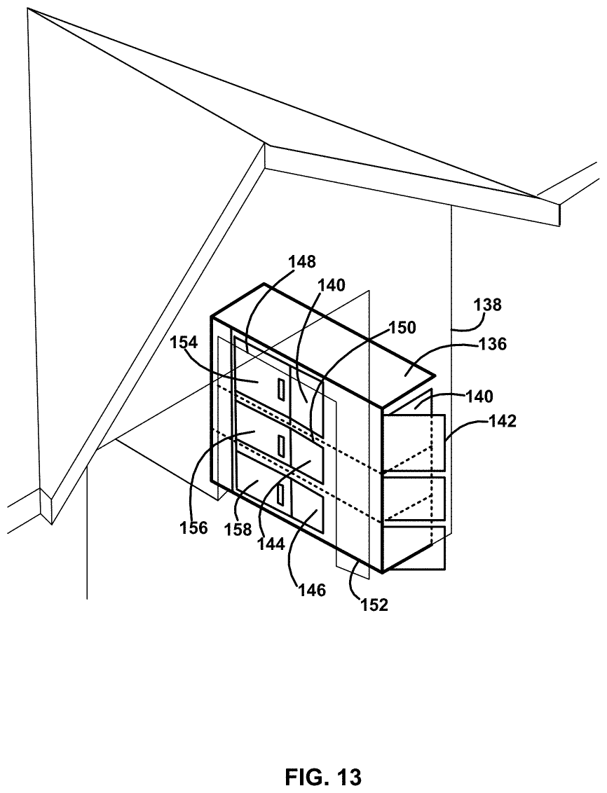

The system may have other forms than shown in FIGS. 1-11. For example, FIG. 13 illustrates an embodiment in which a receptacle 136 is joined with and is within a structure 138. The structure 138 here comprises a residential structure in the form of a residential garage, although in other embodiments different forms of structures may be utilized (e.g., the interior of a home, a shed, and others). The receptacle 136 is configured similarly as the receptacle 12 and may operate similarly as the receptacle 12. For example, the receptacle 136 includes a compartment 140 for receiving a delivery and a barrier 142 configured to move between an opened position for access to the compartment 140 and a closed position to block access to the compartment 140. The receptacle 136 may include a lock configured to lock the barrier 142 in the closed position and configured to be unlocked to allow the barrier 142 to move to the opened position. Other components of the system 10 may be utilized with the receptacle, such as the controller 108 and other components 94, 96, 98, 100, 102, 104, 106, 110.

The barrier 142 is configured to be exposed to the outdoors and accessible by a deliverer 24 without the deliverer 24 entering the garage or the home. Thus, the home may remain secure with the compartment 140 being accessible to the deliverer 24. As shown in FIG. 13, multiple compartments 140, 144, 146 may be utilized, stacked on top of each other. In one embodiment, only one compartment, or one or more compartments may be utilized.

The receptacle 136 is configured to be accessible from within the structure 138. The receptacle 136 may include one or more openings 148, 150, 152 for the user (the member of the household in this case) to access the respective compartment 132, 144, 146 to retrieve the delivery left by the deliverer 24. Thus here, the user 58 does not need to go outside to retrieve the delivery, and may have rapid access to the delivery within the respective compartment 132, 144, 146. For example, barriers 154, 156, 158 of the respective opening 148, 150, 152 may be unlocked, such that the user 58 does not need to provide an unlock indicator to access the delivery within the respective compartment 132, 144, 146 (e.g., the user 58 could slide open the barrier 154, 156, 158 from inside the garage). Such a configuration shown in FIG. 13 may be particularly beneficial in cold weather climates, in which a user 58 may not want to go outside unless necessary.

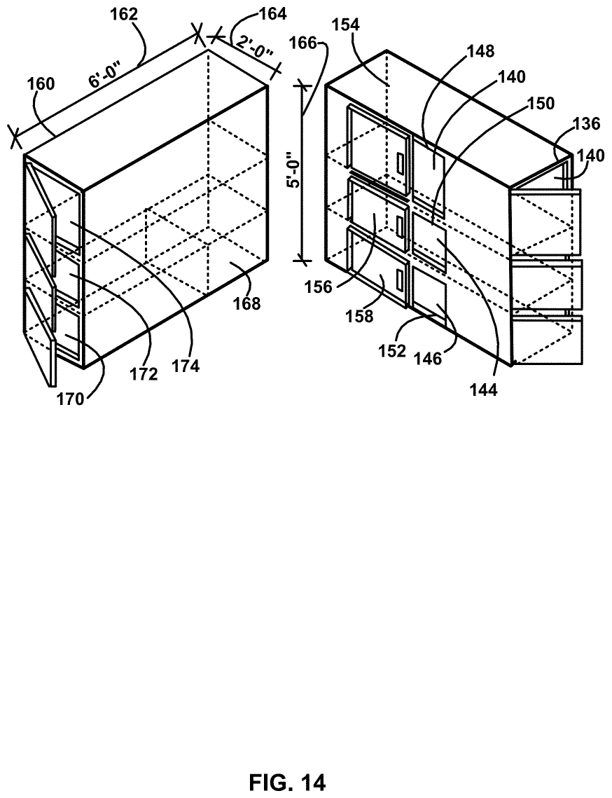

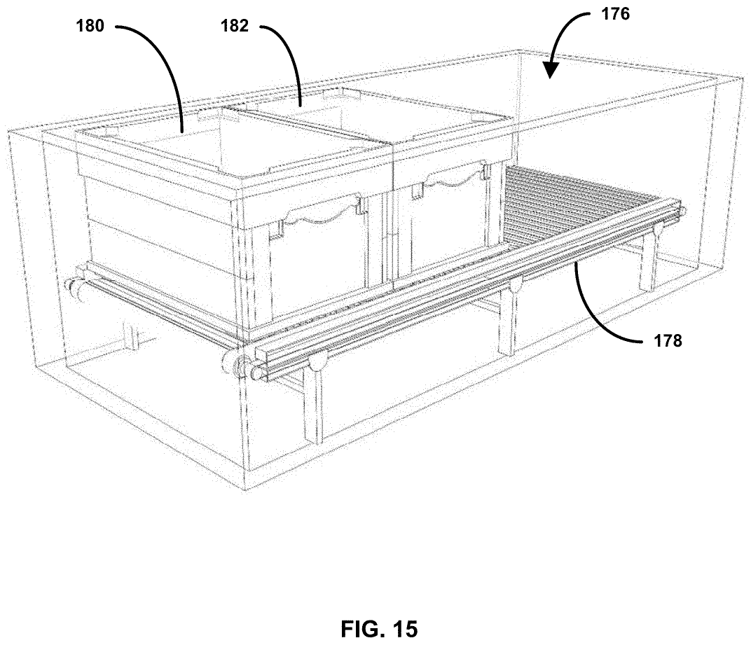

FIG. 14 illustrates a close up view of the receptacle 136 and another receptacle 160 within the scope of this disclosure. The barriers 154, 156, 158 within the structure 138 may comprise sliding doors or other forms of barriers. The receptacle 160 may be configured similarly as receptacle 136 and operate similarly as receptacle 136. The receptacle 160 may include a depth 162, a width 164, and a height 166. The dimensions shown in FIG. 14 are exemplary and may be varied in other embodiments. The receptacle 160 may include a temperature control device 168, such as a refrigerator or freezer device, to make the lowest compartment 170 a temperature controlled compartment. The other compartments 172, 174 may or may not be temperature controlled. The other compartments 172, 174 may be used to receive parcels or the like.

FIG. 15 illustrates a side perspective view of a compartment 176 that may be utilized with a receptacle. The compartment 176 may include a rack 178 positioned therein for supporting containers 180, 182 for receiving deliveries. The compartment 176 may have a depth configured to hold multiple containers 180, 182. The rack 178 may include rollers to allow the containers 180, 182 to be slid backwards when inserted in the compartment 176.

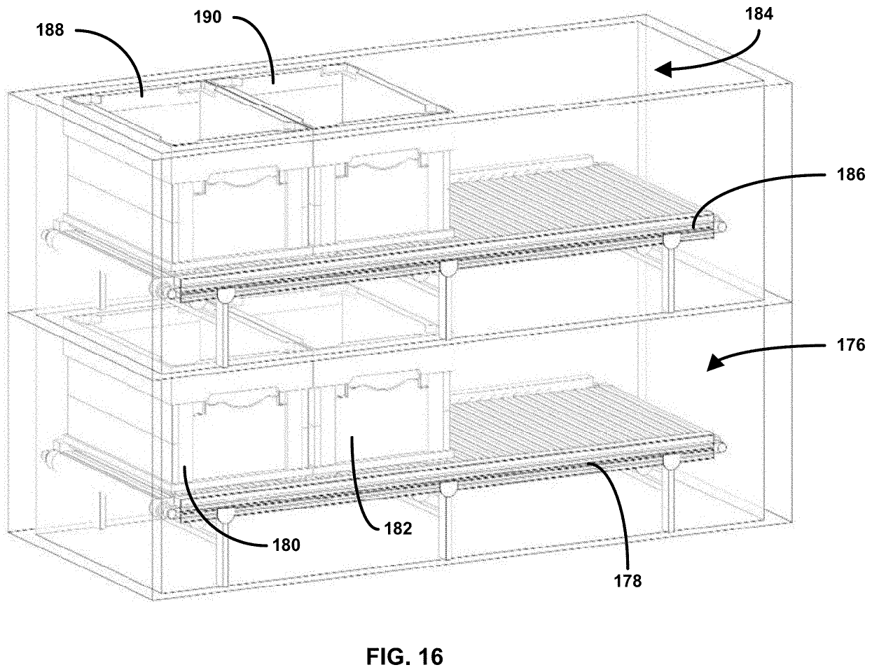

FIG. 16 illustrates a side perspective view of multiple compartments 176, 184 stacked on top of each other as may be used with receptacle 136. Multiple racks 186, 178 and containers 180, 182, 188, 190 are shown. The configuration of the compartments 176, 184 may be utilized with any of the receptacles disclosed herein. The configuration of the receptacles 136, 160 may be utilized in any embodiment disclosed herein.

Referring back to FIG. 1, other components of the system may include the local hub 14. The local hub 14 may comprise a wireless communication device that is configured to communicate wirelessly with the receptacle 12. The local hub 14 may be configured to communicate with one or more mobile communication devices 16, 20, and a central hub 18, as well as other components of the system as desired. The local hub 14 may comprise a computer device such as an “internet-of-things” (JOT) computer device and hub that processes data and routes data among multiple devices, or other form of computer device. The local hub 14 may be configured to receive a communication of the status of the receptacle 12 and communicate the status of the receptacle to the central hub 18. The local hub 14 may be configured to perform all or a portion of the software methods disclosed herein in certain embodiments. In one embodiment, the local hub 14 may be positioned within a residential structure 192 (such as a house or other residential structure) as shown in FIG. 1.

The central hub 18 may comprise a central computer device, such as an internet server or the like, that may process data received from the local hub 14 or other devices of the system. The central hub 18 may be configured to perform all or a portion of the software methods disclosed herein in certain embodiments. The central hub 18 may be an internet server configured for cloud computing, in which the methods disclosed herein are performed in whole or in part remotely by the central hub 18. The central hub 18 may be configured to perform the processing of an “internet-of-things” (IOT) computer device and hub.

The mobile communication device 16 may comprise a mobile computer device such as a mobile phone, a tablet computer, or other form of mobile communication device. In one embodiment, the mobile communication device 16 may be substituted or accompanied in the systems and methods disclosed herein with a non-mobile computer device such as a desktop computer or the like. The mobile communication device 16 may be configured to communicate with the local hub 14, the central hub 18, as well as other components of the system as desired (e.g., directly with the receptacle 12). The mobile communication device 16 may be configured to perform all or a portion of the software methods disclosed herein in certain embodiments.

A mobile communication device 20 of the deliverer 24 may comprise a mobile computer device such as a mobile phone, a tablet computer, or other form of mobile communication device.

The mobile communication device 20 may be configured to communicate with the local hub 14, the central hub 18, as well as other components of the system as desired (e.g., directly with the receptacle 12). The mobile communication device may be configured to perform all or a portion of the software methods disclosed herein in certain embodiments.

The components may communicate wirelessly with each other to perform the methods disclosed herein. In one embodiment, wired connections between the components may be utilized.

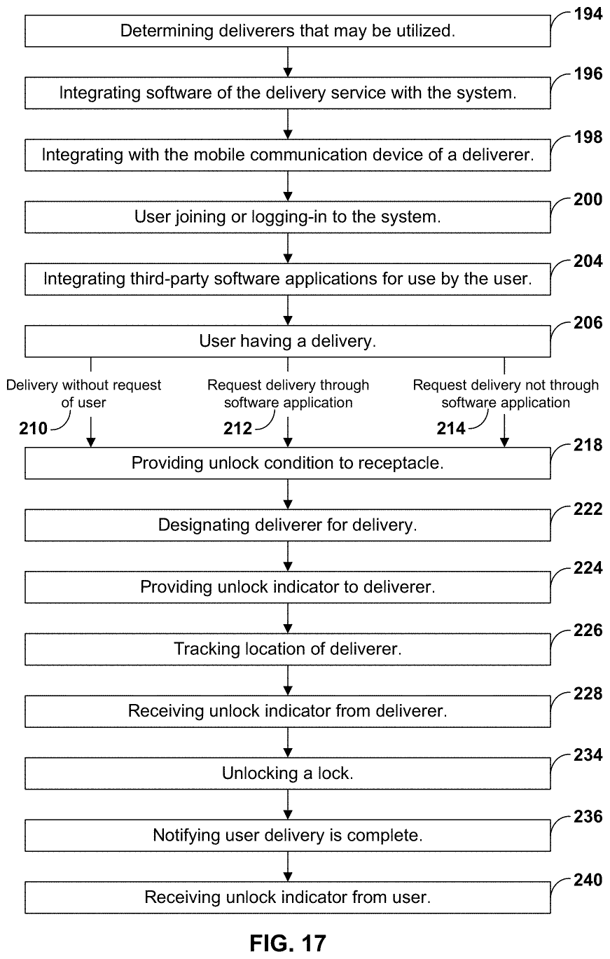

FIG. 17 illustrates a method that may be utilized according to embodiments herein. The method may be performed by one or a combination of the components disclosed herein. The method may comprise a software method that may be performed by the components disclosed herein, either by one of the components or across multiple components. For example, in one embodiment, the method may be operated on the mobile communication device 16 of the user 58. In one embodiment, the method may be performed in combination with the mobile communication device 16, the local hub 14, the central hub 18, the receptacle 12, and the mobile communication device 20 of the deliverer 24, among other components. A combination of the components may be utilized to perform the method as desired.

A step 194 of the method may include determining deliverers that may be utilized for a delivery to the receptacle 12. Such a determination may include engaging individuals or companies to serve as deliverers 24 for deliveries for the user 58. For example, the system may determine a list of deliverers 24 that could possibly provide delivery for the user 58. The list may be compiled by the deliverers 24 submitting requests to the system to serve as deliverers. The system may screen the deliverers 24 to determine suitability for their use with the system. The deliverers 24 may be delivery drivers or other forms of deliverers (e.g., bike or foot deliverers).

Such a determination may also include identifying delivery services for use with the system. The delivery services may comprise parcel delivery services or may comprise on-demand delivery services, among other delivery services. The parcel delivery services may include standard parcel delivery services such as the United States Postal Service (USPS), United Parcel Service (UPS®), FedEx Corporation (FedEx®), and Amazon.com, Inc. (Amazon®), among other parcel delivery services. The on-demand delivery services may be services such as UberEats®, Doordash®, Postmates®, or other delivery services that provide delivery on request of a user 58. Such on-demand delivery services often have a pool of deliverers 24 that operate for the on-demand delivery service (along with other on-demand delivery services). Other delivery services may include grocery stores or product retailers.

For the delivery services, the method may include a step 196 of integrating software of the delivery service with the system. For example, if a delivery service has a software application, the application programming interface (API) may be utilized to integrate the software application of that delivery service with the present system. As such, a user may be able to order a delivery through the third-party software application of the delivery service by using a software application of the present system and/or determine a delivery status of a delivery. The delivery service may be a parcel delivery service or an on-demand delivery service or other delivery service. For example, the system may integrate with the third-party software application of the United States Postal Service (USPS). As such, the system may be able to determine if the user will receive a parcel delivery via the USPS system due to the integration with the software application of the USPS. As another example, the system may integrate with the third-party software application of a grocery store. As such, the system may be able to determine if the user will receive a grocery delivery from the grocery store due to the integration with the software application of the grocery store, and the user may be able to request the delivery from the grocery store through the third-party software application of the grocery store by using the software application of the present system. A similar process may occur with an on-demand delivery service.

Step 198 of the method may include integrating with the mobile communication device 20 of a deliverer 24. The deliverer 24 may comprise a deliverer for one of the delivery services identified in step 194, or may comprise another deliverer. The integration may include providing a software application on the mobile communication device 20 of the deliverer 24. The integration may include accessing the mobile communication device 20 such that a geographic location signal of the deliverer 24 (provided via a global positioning system (GPS)) is available to the system. The integration with the mobile communication device 20 may allow the system to communicate with the deliverer 24, for example, regarding delivery requests or the location of the receptacle 12. The system may also be able to provide an unlock indicator to the deliverer 24 via the mobile communication device 20.

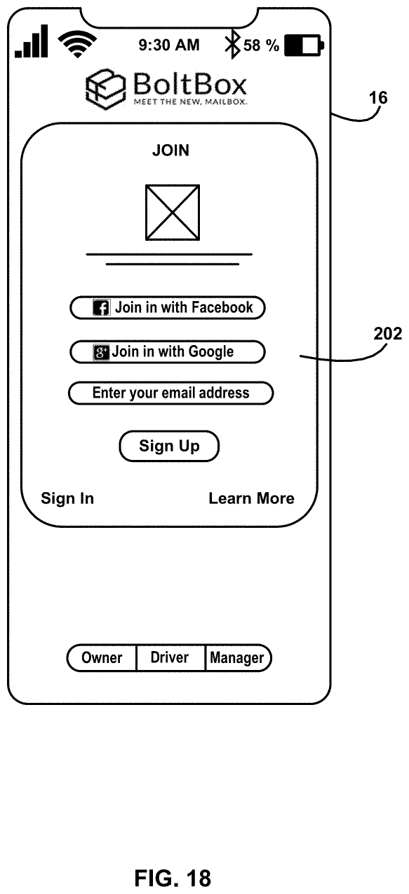

Step 200 of the method may include the user 58 joining or logging-in to the system. FIG. 18 illustrates a screen 202 the user 58 may view to join or log to the system. The system may be presented to the user as a software application (e.g., a mobile application) that the user may interact with via the mobile communication device 16 (or another computer device such as a desktop computer, or directly from the receptacle). The software application may be loaded onto the mobile communication device 16 (or another computer device such as a desktop computer, or the receptacle). The user 58, when joining or logging-in to the system, may provide personal information such as age, address, location, signature (including e-signature), and other personal information. In one embodiment, such personal information may be utilized to automatically authorize delivery of certain deliveries to the receptacle 12. For example, if the user 58 is over a certain age, the system may be configured to automatically authorize delivery of alcohol to the receptacle. If the user provides a signature (or e-signature), then the signature or e-signature may be utilized to automatically sign for a parcel delivery. The user 58 can determine the amount of personal information provided to the software application. The user 58 may comprise the recipient of the delivery, or a user facilitating a delivery for another individual at the receptacle 12 (such as another household member or other individual).

The user 58 may provide other information such as the location and type of the receptacle to receive a delivery.

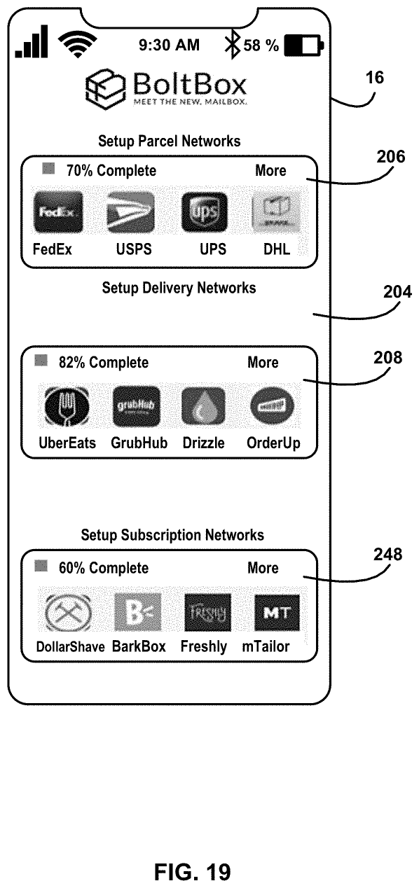

Step 204 of the method may include integrating third-party software applications for use by the user. FIG. 19 illustrates a screen 204 the user 58 may view to integrate third-party software applications for use. The user may be prompted to set up integration with third-party delivery service applications, such as parcel delivery services 206 such as the United States Postal Service (USPS), or on-demand delivery services 208 (such as UberEats®), or other delivery services (such as grocery stores or product retailers). Here, the user 58 may select which third-party software applications are integrated with the software application of the user. If the user does not want a certain third-party software application integrated, then the user may not select such an application. For example, if the user 58 does not want parcel delivery services to deliver to the receptacle 12, then the user 58 may not integrate such third-party software applications with the user's software application.

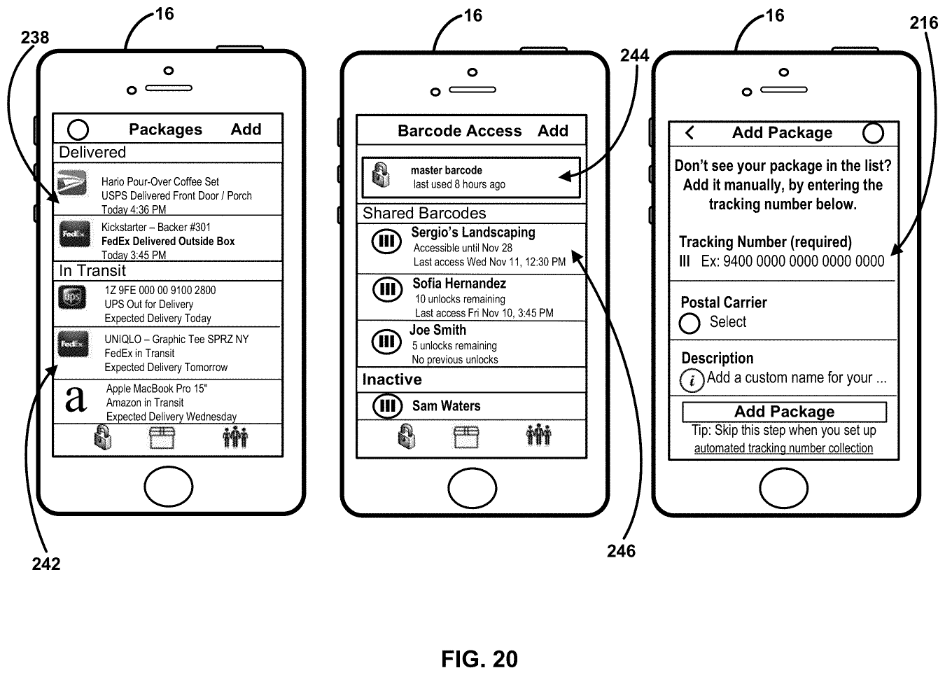

Step 206 of the method may include the user having a delivery. This step may occur in multiple forms (shown as Steps 210, 212, and 214). In one embodiment, the user may have a delivery en-route without the request of the user (shown as Step 208). For example, if an individual is to receive a parcel via a parcel delivery service such as the United States Postal Service (USPS), then the user may not have necessarily requested the delivery. In such an embodiment, the system may determine an unlock condition for the receptacle 12 by retrieving the unlock condition from the parcel delivery service. The system may determine the unlock condition by retrieving a code or symbol, such as a parcel tracking code or symbol. The parcel tracking code or symbol may be retrieved based on the integration of the system with the third-party software application of the parcel delivery service. For example, the system may be able to read the parcel tracking code or symbol from the third-party software application of the parcel delivery service. Alternatively, the system may be able to read the parcel tracking code or symbol from other software applications used by the user, such as an email system. Alternatively, the user may input the parcel tracking code or symbol in the system manually, as represented as item 216 of FIG. 20. In such an embodiment, the unlock condition may comprise the parcel tracking code or symbol.

Upon the system determining the unlock condition, the unlock condition may be provided to the receptacle 12, particularly the controller 108 of the receptacle (step 218). In such a manner, the mobile communication device 16, the local hub 14, and/or the central hub 18 may route the unlock condition to the receptacle 12. Upon receipt of the unlock condition, the controller 108 of the receptacle may have and store the unlock condition. For example, the controller 108 of the receptacle may store the parcel tracking code or symbol. The controller 108 may receive the unlock condition, which is provided based on the software application used by the user.

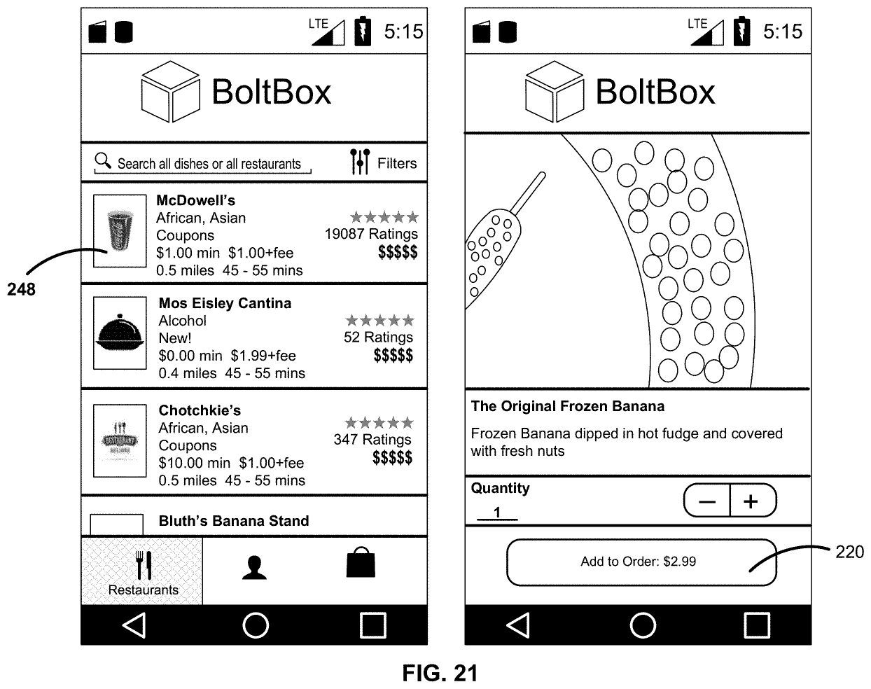

In one embodiment, the user may request the delivery through the software application (shown as Step 212). For example, as shown as item 220 in FIG. 21, the user 58 may request a delivery from an on-demand delivery service through integration with the third-party on-demand delivery service with the system. In such an embodiment, the system may either determine the unlock condition by retrieving an unlock condition from the third-party delivery service (such as an order code or the like of the third-party delivery service), or may determine the unlock condition by generating the unlock condition. The generated unlock condition may have multiple forms, such as a code or a symbol, among others. The system may generate the unlock condition for any form of delivery requested by the user through a software application. In one embodiment, the system may have one or more dedicated delivery services, such that the third-party software applications are not utilized (yet the user still requests the delivery via the present software application of the system).

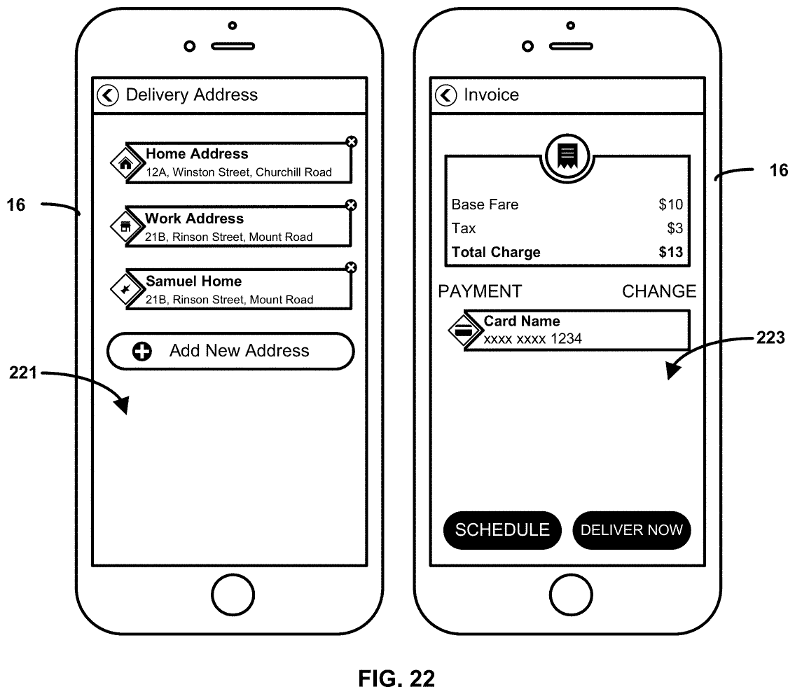

FIG. 22 illustrates screens 221, 223 a user may view on the software application of the mobile communication device 16 to complete the delivery request with the software application.

In a similar manner as in step 218, the system may provide the determined unlock condition to the receptacle 12, particularly the controller 108 of the receptacle 12. The unlock condition may be generated by the system and provided to the controller 108 of the receptacle 12. For example, the controller 108 of the receptacle 12 may store the generated code or symbol. The controller 108 may receive the unlock condition, which is provided based on the software application used by the user.

In one embodiment, the user 58 may request the delivery but not through any software application (shown as step 214). For example, the user 58 may make a telephone call or a personal request to a delivery service and request the delivery in that manner. The system, however, may still determine an unlock condition by generating a code or other form of unlock condition. The unlock condition may be generated upon the request of a user. For example, if the user requests a delivery over a telephone call with a small business, then the software application may generate a code, and the code may be provided verbally to the deliverer for the small business. In such a manner, the system may be utilized to receive deliveries from businesses that do not have software or computerized communications with delivery recipients.

In a similar manner as in step 218, the system may provide the determined unlock condition to the receptacle 12, particularly the controller 108 of the receptacle 12. The unlock condition may be generated by the system and provided to the controller 108 of the receptacle 12. For example, the controller 108 of the receptacle 12 may store the generated code or symbol. The controller 108 may receive the unlock condition, which is provided based on the software application used by the user.

Step 222 of the method may include designating a deliverer for the delivery. In an embodiment in which the delivery service has dedicated deliverers (such as with the United States Postal Service (USPS)), such a step may not occur. However, in an embodiment in which a third-party software application is utilized, or a dedicated delivery service is utilized, a deliverer may be requested by the system. The system may offer the delivery to multiple deliverers and may receive an acceptance of the delivery request from one of the deliverers. The system may have dedicated deliverers, and if none of the dedicated delivers accepts the delivery request then the deliverers of the third-party delivery services may be offered the delivery. In one embodiment, the system may receive a referral fee if the third-party deliverers accept the delivery request.

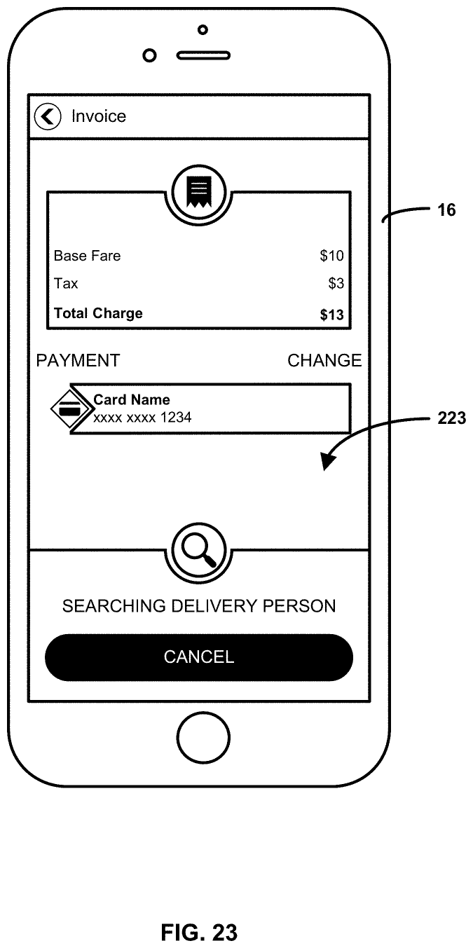

FIG. 23 illustrates a screen 223 a user 58 may view on a software application of the mobile communication device 16 as the system designated a deliverer for the delivery.

Step 224 of the method may include providing an unlock indicator to the deliverer 24. The unlock indicator may comprise a code or symbol, or other form of unlock indicator, that satisfies the unlock condition. For example, if the unlock condition is a code or symbol, the unlock indicator may comprise a matching code or symbol that notifies the receptacle 12 that the desired deliverer 24 is present. In an embodiment in which the system generates a code or symbol (the unlock condition), the system may provide the same code or symbol to the deliverer 24.

In certain embodiments, the unlock indicator may not be provided to the deliverer 24. For example, in an embodiment in which the code is retrieved (such as with a tracking code retrieved from the United States Postal Service (USPS)), the code may not be provided to the deliverer 24. The deliverer presumably may already have the unlock indicator (in the form of the tracking number printed on the parcel to be delivered). The deliverer thus may not need the unlock indicator delivered to them.

The unlock indicator may be provided to the deliverer 24 in a variety of forms. For example, the unlock indicator may appear on the mobile communication device 20 of the deliverer 24 or otherwise be provided to the deliverer 24. The unlock indicator may be transmitted to the deliverer 24 wirelessly (for example via the central hub 18). In one embodiment, the unlock indicator may comprise a code or symbol positioned on an order receipt for the delivery.

Step 226 of the method may include tracking the location of the deliverer 24 approaching the receptacle 12. In such a step, the system may track a geographic location signal (such as a global positioning system (GPS) signal) of the deliverer 24 through the mobile communication device 20 or another computing device. The geographic location of the deliverer 24 may be provided to the user via the system, for example for view by the user 58 on the mobile communication device 16. In one embodiment, the system may provide the geographic location of the receptacle 12 to the deliverer 24, which may be for view by the deliverer 24 on the mobile communication device 20 of the deliverer 24. The system may utilize the global positioning system of the receptacle 12 to provide the global positioning system indicator of the geographic location of the receptacle 12 to the deliverer 24.

In one embodiment, the system may cause the indicator 110 to operate based on the location of the deliverer 24. For example, as the deliverer comes within a certain geographic range of the receptacle 12, the indicator 110 may operate to indicate the location of the receptacle 12 to the deliverer 24. For example, as the deliverer 24 approaches, the light may shine brightly into the air, to provide a visual landmark for the deliverer 24. The speaker may sound to provide an auditory cue of the location of the receptacle 12. In such a manner, the deliverer 24 may more quickly determine the location of the receptacle 12 and may determine the appropriate place of delivery more rapidly. The system may provide the geographic location of the deliverer 24 to the controller 108, and may provide an instruction to the controller to operate the indicator upon the deliverer 24 being within a geographic range of the receptacle 12.

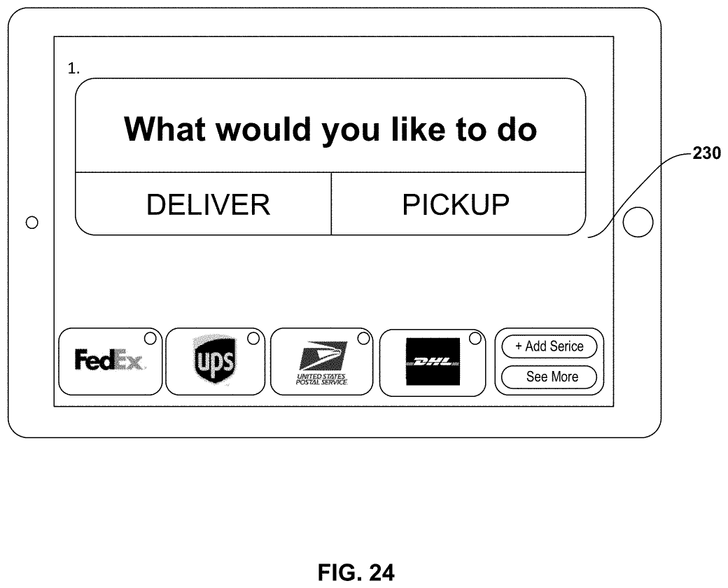

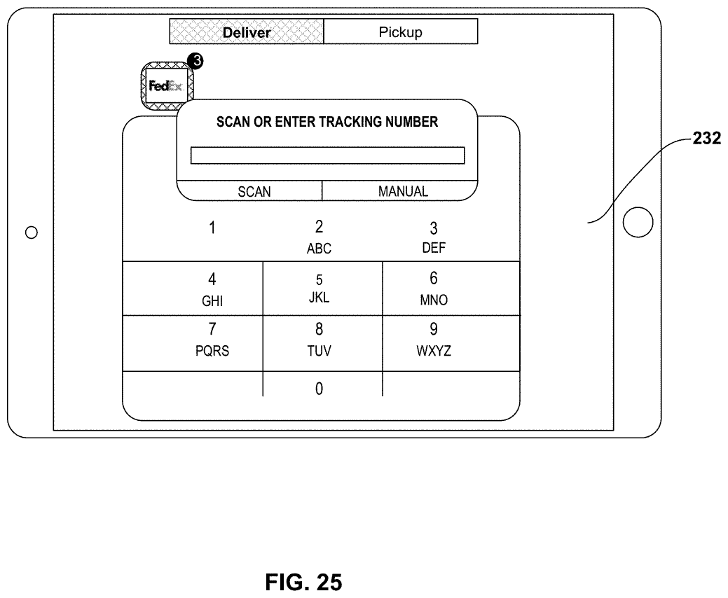

Step 228 of the method may include receiving the unlock indicator from the deliverer 24. The unlock indicator may be provided by the deliverer 24 by the deliverer 24 inputting the unlock indicator into one or more of the input devices of the receptacle 12. For example, the deliverer 24 may view a screen 230 on the touch screen 98 as shown in FIG. 24. If the unlock indicator is a parcel tracking code, the parcel tracking code may be input onto the screen 232 of the touch screen 98 or keypad 102 by the deliverer 24, as shown in FIG. 25. If the unlock indicator is a symbol, the symbol may be read by the scanner 100.

Step 234 of the method may include unlocking a lock 96 based on the receipt of the unlock indicator from the deliverer 24 that satisfied the unlock condition. The controller 108 here may determine whether the unlock indictor satisfies the unlock condition and may unlock a lock 96 to allow the respective barrier 48, 50, 52 to be moved to the opened position to allow the deliverer 24 to place the delivery in the respective compartment 54, 60, 82. The unlock indicator may match the unlock condition. The deliverer 24 may then close the barrier (move to the closed position) and leave after the delivery is completed.

Step 236 of the method may include notifying the user 58 that the delivery is complete. The controller 108 may be configured to determine that the delivery has been made through a variety of methods. For example, the controller 108 may determine that the barrier 48, 50, 52 has been moved to the closed position after being in the opened position. The controller 108 may determine what delivery has been made by the nature of the unlock indicator being provided to the controller 108 by the deliverer 24. The controller 108 may determine that a particular delivery has been made by matching the unlock indicator with that particular delivery. The controller 108 may provide a notification that the particular delivery has been made and the delivery has been placed within the compartment, which may be routed to the user's mobile communication device 16. Item 238 of FIG. 20 illustrates a queue that may be provided to the user 58 showing the delivery and delivery type that has been made to receptacle 12.

Step 240 of the method may include receiving an unlock indicator from the user 58 to retrieve the delivery. The unlock indicator may have a variety of forms, for example, a code, a symbol, a physical characteristic, or a proximity. For example, the unlock indicator of the user 58 may comprise the user's fingerprint (a physical characteristic). In one embodiment, the unlock indicator may comprise the image of the user's face (a physical characteristic). In one embodiment, the proximity of the user 58 to the receptacle 12 may automatically unlock the receptacle.

The steps of the method detailed above may be varied, modified, excluded, or substituted as desired. The steps of the method may be varied, modified, excluded, or substituted with features described below.

In one embodiment, the system may be configured to determine what compartments 54, 60, 82 are available for delivery and what compartments 54, 60, 82 already have a delivery. The system may be configured to keep track of which compartments have already received a delivery. The controller 108 may be configured to make such a determination by tracking the opening and closing of the compartments 54, 60, 82, and may track the unlock indicators for such compartments. In one embodiment, a sensor such as a scale may be utilized by the receptacle to determine if a delivery is present in a compartment.

In one embodiment, the system may be configured to provide a list to the user of which deliveries are present in the receptacle 12 as well as a list of which deliveries are scheduled to be provided to the receptacle 12. For example, FIG. 20 illustrates a delivery queue 242 that may be displayed to the user 58. The system or the user 58 may be configured to vary the queue to set which order the deliveries will occur.

In one embodiment, the system may be configured to determine if no compartments 54, 60, 82 are available for delivery. For example, a method may be performed in which if the user 58 requests a delivery, and there is no compartment 54, 60, 82 available for delivery, then the system may automatically notify the deliverer 24 not to make the delivery. In one embodiment, the system may be configured to automatically schedule the time of the delivery so that a compartment 54, 60, 82 will be available for the delivery, for example the system may be configured to delay the delivery until a compartment is available.

In one embodiment, the system may be configured to determine which compartment 54, 60, 82 to open for a deliverer 24 based on which compartment is available for delivery. For example, if a receptacle has three compartments 54, 60, 82, with the first two of the compartments 54, 60 full, then the system may be configured to open the third compartment 82 upon the deliverer 24 providing the unlock indicator to the receptacle.

In one embodiment, the system may be configured to determine the type of delivery to be provided. For example, the system may be configured to automatically determine the type of delivery based on the type of delivery service utilized to make the delivery. The system may be configured to make a determination based on the type of third-party application utilized to make the delivery. If a delivery is to be provided by a grocery store delivery, then the system may be determine that a perishable delivery is to be made. If a delivery is to be provided by a parcel delivery service, then the system may determine that a parcel delivery (which may be non-perishable) is to be made. If a delivery is to be provided by an on-demand food delivery service, then the system may be determine that a perishable delivery is to be made. In one embodiment, the system may be configured to determine the type of delivery to be provided by retrieving the type of delivery to be made. For example, for a parcel, the system may be configured to retrieve the type of parcel to be provided. In one embodiment the user may input the type of delivery to be provided.

In one embodiment, the system may be configured to open a temperature controlled compartment 54, 60, 82 based on the type of delivery to be provided. The type of delivery may be provided to the controller 108. For example, if the system determines that a perishable delivery is to be provided, then the system may open the lock for the temperature controlled compartment 54, 60, 82 for the deliverer of the perishable delivery (rather than a non-temperature controlled compartment). If the system determines that a non-perishable delivery (such as a parcel) is to be delivered, then the system may open the lock for a non-temperature controller compartment. In this manner, the system may allocate perishable deliveries to the temperature controlled compartment. In one embodiment, if the system determines that the temperature controlled compartment is not available (for example because full with another delivery), then the system may automatically deny delivery of a perishable delivery, or may delay delivery of a perishable delivery.

In one embodiment, the system may be configured to automatically vary a temperature of a temperature controlled compartment 54, 60, 82 based on the type of delivery be provided. For example, if the system determines that a perishable delivery is to be delivered, then the system may automatically operate the temperature control device 94 to reduce the temperature to a refrigerated state. Such a delivery may be a grocery delivery or the like. If the system determines that a frozen delivery is to be delivered (such as ice cream or the like), then the system may automatically operate the temperature control device to reduce the temperature to a freezer state. If the system determines that a warm or hot perishable prepared food delivery is to be made, then the system may automatically raise the temperature to a warming state, to keep the meal warm until the user retrieves the delivery. In one embodiment, the system may vary the temperature based on the ambient temperature. For example, if the temperature is freezing outside, then the system may raise the temperature in the compartment to prevent the delivery from freezing.

In one embodiment, the system may be configured to automatically vary a temperature of a temperature controlled compartment 54, 60, 82 based on the proximity of the deliverer 24. For example, if the system determines that a deliverer 24 is within a radius of the receptacle 12, then the system may automatically operate the temperature control device 94 to lower or raise a temperature of the temperature controlled compartment (so as to conserve energy in maintaining a temperature when the deliverer is not near). The system may provide an instruction to the controller 108 to lower a raise a temperature of the compartment 54, 60, 82 based on the deliverer 24 being within a geographic range of the receptacle 12. The system may utilize the GPS signal of the deliverer for such an operation.

In one embodiment, the system may be configured to receive input from the user 58 regarding whether the temperature of the temperature controlled compartment should be varied. For example, the user may request whether a compartment should have its temperature varied for a certain delivery, or whether a certain delivery should be positioned within a temperature controlled compartment. The system may be configured to receive input from the user regarding whether any pre-cooling or pre-heating for a temperature controlled compartment should be provided before the delivery arrives.

In one embodiment, the receptacle 12 and one or more compartments 54, 60, 82 therein may be dedicated for use by a single user, or single account with the system (which may have multiple users). The receptacle may be for personal use by a user or may be for use by a household. In one embodiment, compartments of the receptacle may be dedicated for use by different users or accounts. For example, in an apartment community or other form of housing community, one receptacle may be utilized by multiple users or accounts. In one embodiment, each user or account may have a dedicated compartment for use. In one embodiment, each user or account may utilize a variety of the compartments.

In one embodiment, the system may not only include one receptacle 12, but may include multiple receptacles, each which may be configured as discussed herein. The multiple receptacles may be configured to communicate with each other, and may be configured to communicate a status wirelessly to components such as the local hub 14, the mobile communication device 16, and/or the central hub 18. The system may be configured to allocate deliveries to multiple receptacles. For example, if one receptacle indicates that it is full, then the system may allocate the next delivery to a second receptacle.

In one embodiment, the controller 108 of the receptacle 12 may have an unlock condition that is always available to unlock a lock 96. Such an unlock condition may comprise a “master” unlock condition, such as the master code illustrated as item 244 in FIG. 20. The unlock condition may be provided to the controller 108 of the receptacle 12, and may be defined by the user 58 with the software application of the present system. For example, the user 58 may input a master unlock condition using the software application and that unlock condition may be provided to the controller 108 based on the software application used by the user. The system may be configured to provide that master unlock condition to a deliverer 24 if desired by the user. In other embodiments, the system may have dedicated unlock conditions for certain deliverers or delivery services. For example, as shown in item 246 in FIG. 20, the controller 108 of the receptacle 12 may have unlock conditions that are dedicated for certain deliverers or delivery services and are provided to the respective deliverers or delivery services. The system may provide these unlock conditions to the controller 108 based on the software application used by the user 58. As such, the controller 108 may be able to unlock the lock based on unlock indicators being provided to the controller 108 that match these unlock conditions.

The unlock conditions and unlock indicators are not limited to codes or symbols. For example, the controller 108 may be provided with an unlock condition indicating that a deliverer 24 has a certain proximity. The unlock indicator may comprise the proximity of the deliverer 24. In this manner, a deliverer 24 may simply have to approach the receptacle 12 to have the receptacle 12 unlock a compartment. The deliverer 24 may emit a wireless signal (an unlock indicator) upon reaching a certain proximity to the receptacle 12. The wireless communication device 116 of the controller 108 may configured to receive such an unlock indicator. The unlock indicator in other embodiments, may be a radio-frequency identification (RFID) device (such as an RFID tag), a finger print, a facial appearance, a wireless signal emitted by the deliverer (such as the deliverer's mobile communication device 20) or other form of indicator. In one embodiment, a physical characteristic of the deliverer may comprise the unlock indicator. One or more of the scanner 100, the keypad 102, the touch screen 98, the sensor 104, the camera 106, or the wireless communication device 116 may be configured to receive the unlock indicator. The controller may be provided with an unlock condition indicating these unlock indicators based on the software application used by the user.

In one embodiment, the unlock indicator may be set to expire after a certain period of time.

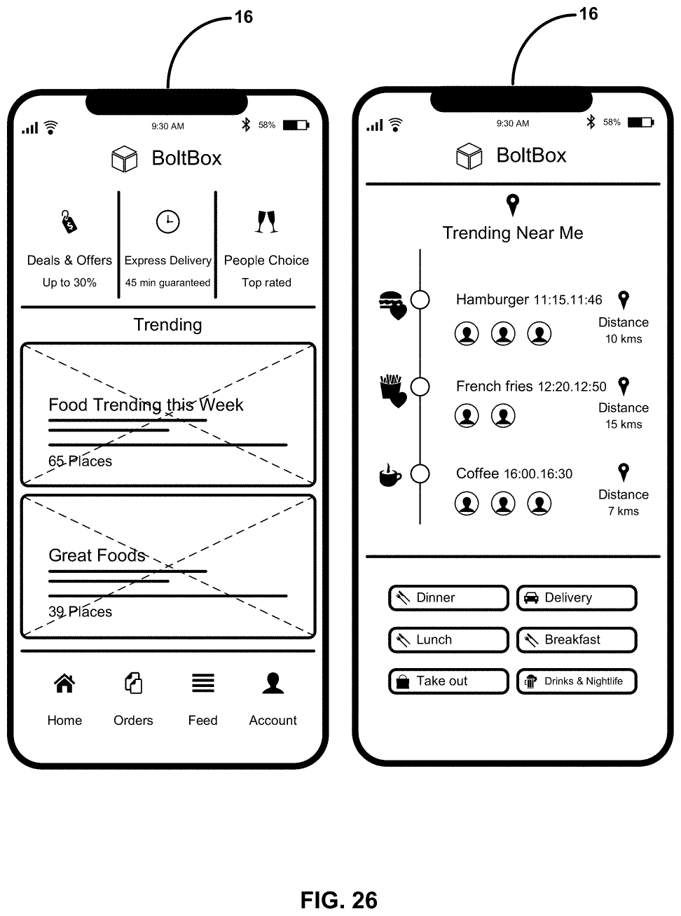

In one embodiment, the system may provide offerings of deliveries to the user 58. The offerings may be visible on the software application utilized by the user. For example, as shown in FIG. 26, the system may offer food deliveries to the user. The food deliveries may be for delivery through the system. FIG. 21, for example, illustrates a variety of offerings 248 to the user through the system. The deliveries may be ordered through the software application of the system, or may be ordered through third-party software applications integrated with the software application of the system.

In one embodiment, the system may provide an online marketplace for retailers to offer products for delivery to the user 58. For example, the retailers may sign-up with the system and have their offerings displayed to the user 58 on the software application utilized by the user. The user 58 may be able to purchase the delivery on the online marketplace, and have the delivery provided to the receptacle in a manner disclosed herein.

In one embodiment, the system may provide a subscription of a delivery to the user. FIG. 19, for example, illustrates third-party software applications 248 that may integrate with the system and may offer subscription products to the user 58. A repeated product, such as shaving razors, may be desired by a user on a periodic basis (e.g., weekly, monthly), and the system may allow for and coordinate delivery of the delivery on a subscription basis. The user may select, using the software application, which deliveries to subscribe to.

In one embodiment, the system may offer deliveries of sample products to the user 58. For example, the user may be able to receive free products in the receptacle. The free products may be delivered on a periodic basis from a variety of delivery services. The user may select to no longer receive sample products if desired.

In one embodiment, the system may provide for delivery between users of the system. For example, the system may provide a marketplace in which one user may see what items are available for sale or transfer by another user. The system may provide a marketplace in which a first user 58 may offer to a second user an item of the first user 58. If the second user selects the item, then the first user 58 may place the item within the receptacle 12. The system may automatically notify the second user that the item is within the compartment of the receptacle 12. The second user may receive the unlock indicator to unlock the compartment and may retrieve the item from the receptacle. FIG. 24, for example, illustrates the option to “pick up” from the receptacle 12. The first user 58 may receive a notification that the second user has retrieved the item. Any funds transferred between the two users may be automatically transferred within the system. In such a method, the communication between the users may occur through the central hub 18 shown in FIG. 1.

In one embodiment, the offering to the second user may not be a direct offering, and may be a general offering that reaches the second user. For example, the marketplace may be a general offering of the item. In addition, the first user 58 may place the item in the receptacle 12 prior to the item being selected by the second user. In this manner, the first user 58 may generally offer the item to any willing purchaser/transferee, and leave the item for pick-up within the receptacle 12. The first user 58 thus may not need to be present or coordinate a pick-up schedule for the item with the second user because the item is already available in the receptacle. Funds may be automatically transferred upon the second user's pick up or purchase of the item.

In one embodiment, a user to user transaction may occur without use of a marketplace. For example, a first user 58 may simply notify a second user that an item is available for pick-up in the receptacle 12 and the second user may pick up the item according to methods disclosed herein.

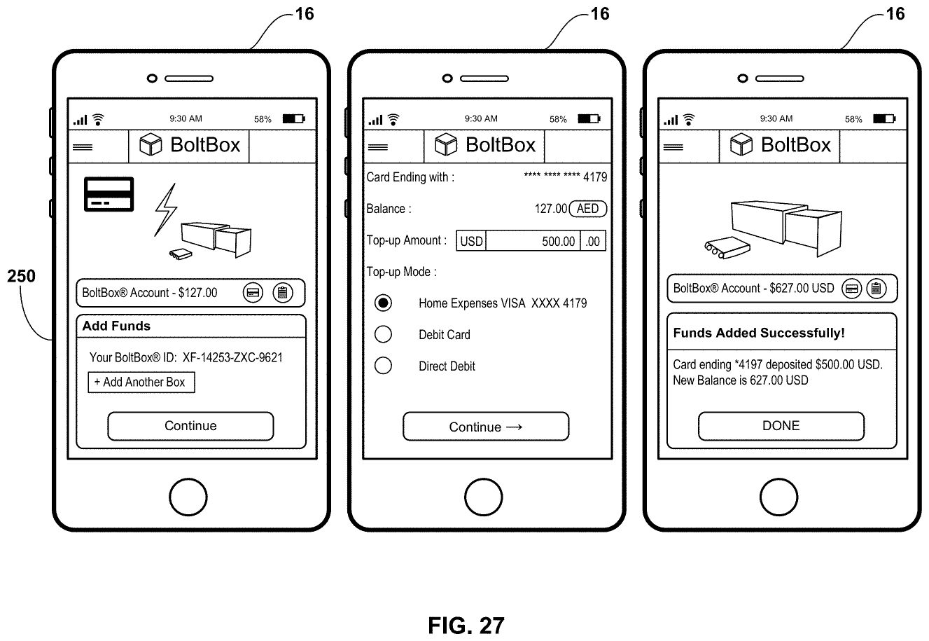

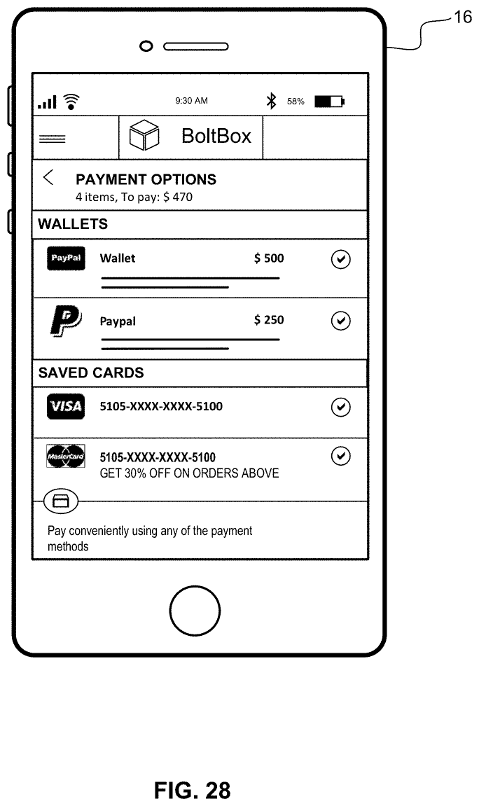

In one embodiment, the system may provide a fund account to the user 58. FIG. 27, for example, illustrates that funds may be added to a fund account 250. The fund account 250 may be for use by the user to purchase deliveries, and may receive funds from other users for sales/transfers between users. In one embodiment, the funds may be allocated to certain account users of an account. For example, in a household account the funds may be allocated to children on the account, so that the children may purchase food deliveries or the like, and not have access to a standard credit card or other payment method of the parents. The parents may add or remove funds to and from the fund account as desired. Payments through the system may otherwise be made through a standard payment method, as represented in FIG. 28.

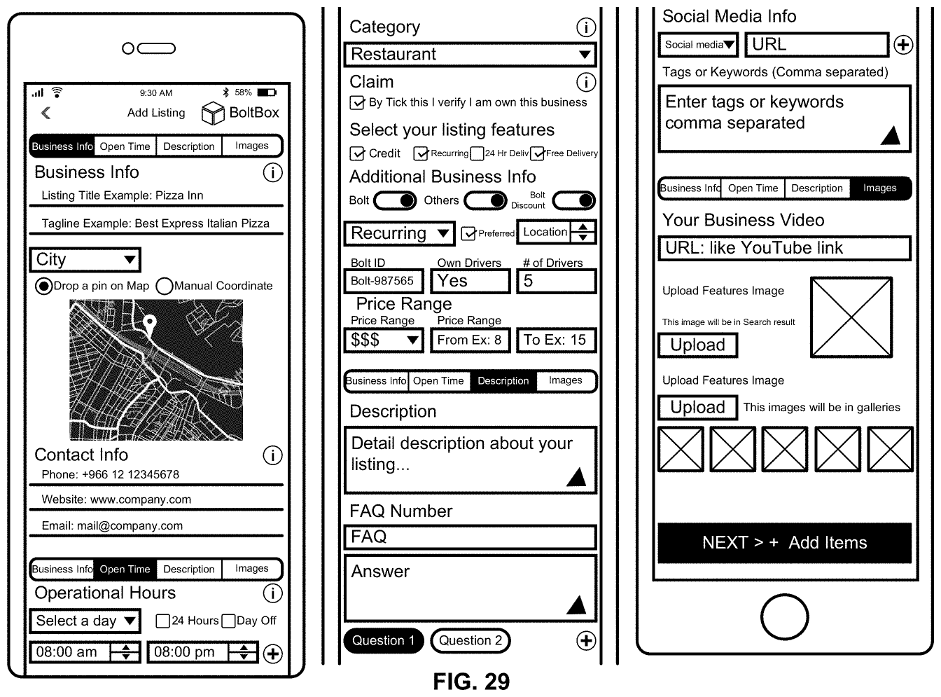

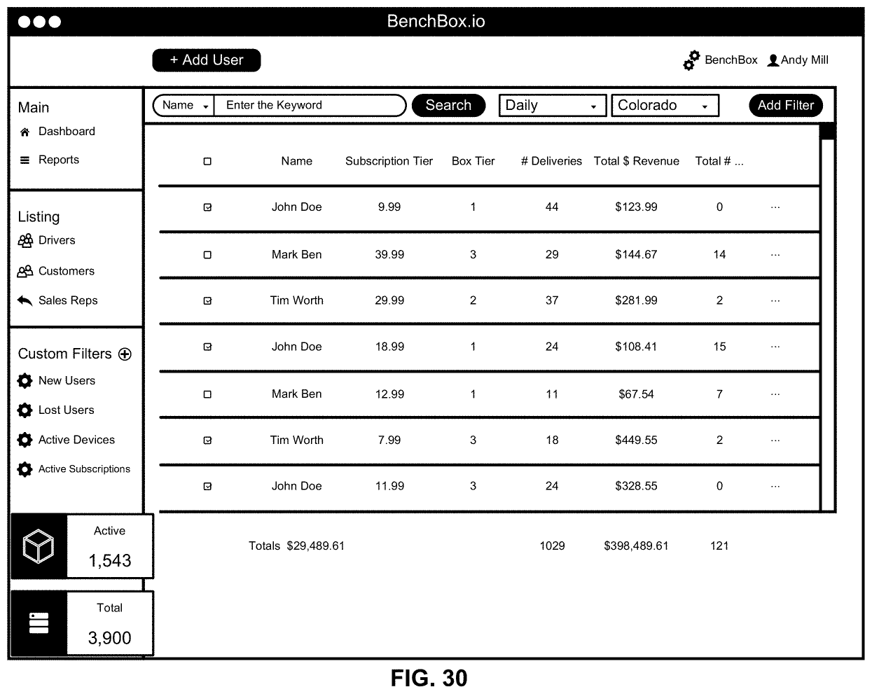

FIG. 29 illustrates a sign up process that may be entered by a delivery service. The delivery service may provide identifying information regarding the delivery service and may offer deliveries to the user through the system. FIG. 30 illustrates information that may be provided to a delivery service for use by the delivery service. Such information may include the total revenue provided through deliveries to multiple delivery receptacles.

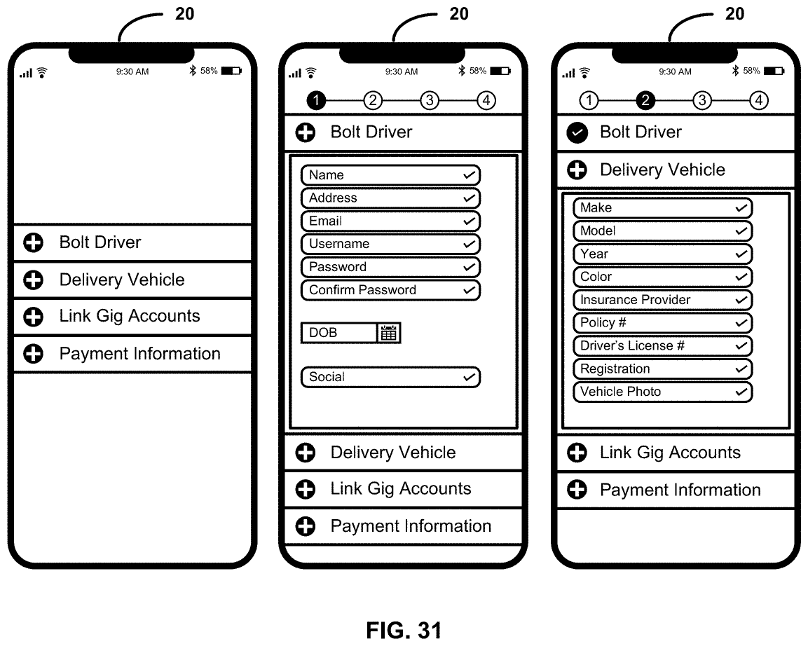

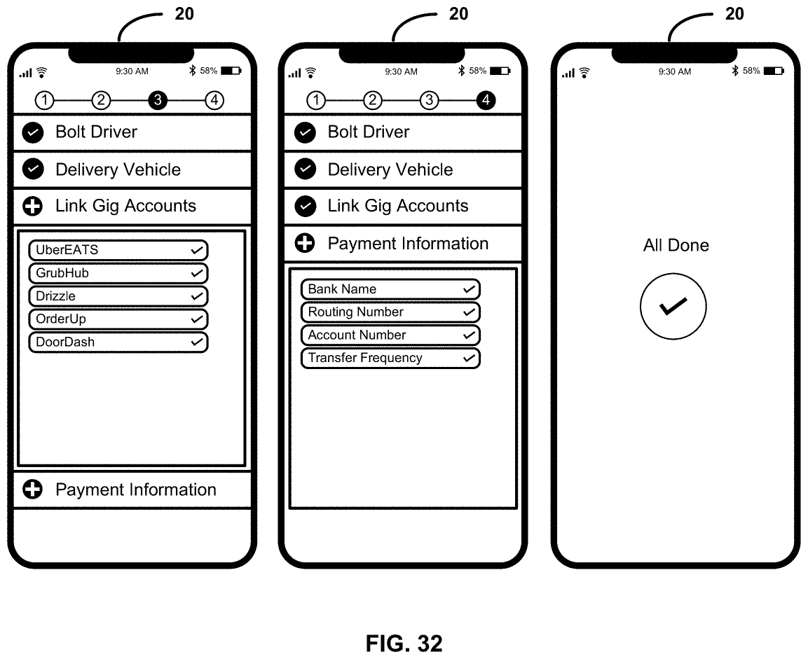

FIGS. 31 and 32 illustrate information that may be provided by deliverers 24 when submitting requests to the system to serve as deliverers 24. Such information may include a variety of identifying information for the deliverers 24.

In one embodiment, referring back to FIG. 1, the mobile robot 26 may be utilized within the methods herein. In one embodiment, the mobile robot 26 may serve as the receptacle discussed herein. For example, the mobile robot may include the same functionality and operation disclosed herein as the receptacle 12, yet may be mobile. The mobile robot 26 may be configured to move to delivery locations to receive the delivery. The mobile robot may be instructed to move to a delivery location to receive the delivery by the system. In one embodiment, the mobile robot may move to a curb 252 or other designated delivery point to be provided with the delivery. The deliverer 24 may provide the unlock indicator to the mobile robot 26 and the barrier 128 may become unlocked in a similar manner as discussed regarding the barriers 48, 50, 52. The mobile robot 26 may then return to the mobile robot receptacle 32. The barrier 120 may close and secure the mobile robot 26 within the mobile robot receptacle 32. The mobile robot 26 may comprise the receptacle or may be configured to communicate wirelessly with the receptacle 12 or the local hub 14 or other components of the system to receive instructions, including movement instructions. For example, the controller 108 of the receptacle 12 may be configured to communicate with the mobile robot 26 to receive the delivery and move the delivery to the compartment 122 of the mobile robot receptacle 32.

In one embodiment, the mobile robot 26 may be configured to travel to a designated delivery point that is not on the property of the user 58. For example, the mobile robot 26 may be configured to travel to a remote destination, such as the place of business of the delivery service, and receive the delivery. Thus, the deliverer 24 does not need to travel to provide the delivery to the mobile robot 26. The mobile robot 26 may then return to the property of the user 58 or other designated point.

In one embodiment, when the mobile robot 26 is not in use, it may be utilized to perform household chores for the user. For example, the mobile robot 26 may be equipped with one or more of a snow plow, lawn mower, fertilizer distributor, or other device. The mobile robot 26 may operate on an automatic schedule to perform the household chores.

The mobile robot receptacle 32 is shown to be adjacent the receptacle 12 in FIG. 1, however, in other embodiments may comprise the base of the receptacle 12.

In one embodiment, the delivery drone 28 may be utilized within the methods herein. In one embodiment, the delivery drone 28 may serve as the receptacle discussed herein. For example, the delivery drone may include the same functionality and operation disclosed herein as the as the receptacle 12, yet may be mobile. The delivery drone 28 may be configured to move to locations to receive the delivery, such as the place of business of a delivery service. The deliverer 24 may provide the unlock indicator to the delivery drone 28 and the barrier 134 may become unlocked in a similar manner as discussed regarding the barriers 48, 50, 52. The delivery drone 28 may then return to the drone landing pad 30. The delivery drone 28 may comprise the receptacle or may be configured to communicate with the receptacle 12 or the local hub 14 or other components of the system to receive instructions, including movement instructions. For example, the controller 108 of the receptacle 12 may be configured to communicate with the delivery drone 28 to receive the delivery and move the delivery to the drone landing pad 30.

In one embodiment, when the delivery drone 28 is not in use, it may be utilized to perform surveillance for the user. For example, the delivery drone 28 may utilize the camera or the like to determine when individuals are approaching the property. The delivery drone 28 may operate on an automatic schedule to perform the surveillance.

In one embodiment, the delivery drone 28 may be utilized to transfer items from receptacle to receptacle, for example, for user to user transactions of items.

In one embodiment, the system may include a trailer system that may be positioned at designated points such as retail locations. The trailers may be filled by retailers and the system may coordinate deliverers to pick up the trailers and deliver deliveries from the trailers to the receptacles disclosed herein.

In one embodiment, the receptacles discussed herein may also include a standard mail slot for receiving mail deliveries from the postal service. The receptacles may be positioned at or near the curb of a residential property for ease of access by the postal service or another deliverer.

In one embodiment, the receptacles discussed herein, the mobile robots, and the delivery drones may be solar powered through use of solar panels. In an embodiment in which a receptacle is solar powered, it may be completely free standing with no attachment power cords or the like. In one embodiment the receptacle may be powered through a power cord.

The receptacles, mobile robots, delivery drones, and mobile communication devices may comprise components of an IoT system and may configured to communicate wirelessly with each other according to the methods disclosed herein. The user 58 may be able to receive status updates and control the receptacles, mobile robots, delivery drones with the mobile communication device 16 (or other form of computing device).

In one embodiment, the receptacle 12 may include the software application that is utilized by the user to perform all or a portion of the methods disclosed herein. For example, the user may utilize a display of the receptacle to request a delivery or perform another method disclosed herein.

In one embodiment, the methods disclosed herein may be performed on a single computing device as appropriate. For example, the methods disclosed herein may be performed on the central hub, which may comprise a server. In other embodiments, the methods disclosed herein may be performed on multiple computing devices, for example across the mobile communication devices, controllers, local hubs, central hubs, and mobile communication devices of the deliverers.

The systems, methods, and devices disclosed herein may beneficially allow a user to enhance the means by which the user receives deliveries, and may enhance the means by which the user may transfer items to other users. The user may beneficially have a secure receptacle by which to receive deliveries such that the individual does not need to be physically present or schedule being physically present for a delivery. Rather, the user may be able to go on with his or her personal schedule without having to wait for a delivery. In addition, the user beneficially has reduced concern that a delivery may be stolen from the user's property. The deliverer has a secure location to provide the delivery, without simply leaving the delivery on the user's front porch (as is normally done). Further, with a temperature controlled compartment, the user has reduced concern regarding perishable foods undergoing spoliation before the user picks up the delivery.

In addition, a deliverer may be able to more quickly provide deliveries without having to check if the user is on the property, and without having to receive signature for a delivery. Thus, the deliverer may have more rapid and successful deliveries.

In addition, the improved processing methods may provide enhanced means to provide unlock indicators to deliverers, and have the unlock indicators satisfy unlock conditions of the receptacles. The system may provide an efficient means for deliverers to unlock and deliver deliveries to the receptacles and to notify the users that the deliveries have been made.

The methods disclosed herein may be performed in the sequence disclosed herein or may be performed out of sequence. Any portion of the methods disclosed herein may be varied, modified, excluded, or substituted as desired. The components may be modified, substituted, or excluded as desired, including across embodiments disclosed herein.

In one embodiment, all or a portion of the processes disclosed herein may be embodied on a non-transitory computer readable medium that may store a program causing a processor to execute all or a portion of the processes disclosed herein.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of systems, devices, and methods as disclosed herein, which is defined solely by the claims. Accordingly, the systems, devices, and methods are not limited to that precisely as shown and described.

Certain embodiments of systems, devices, and methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, devices, and methods to be practiced otherwise than specifically described herein. Accordingly, the systems, devices, and methods include all modifications and equivalents of the subject matter recited in the claims appended hereto as permitted by applicable law. Moreover, any combination of the above-described embodiments in all possible variations thereof is encompassed by the systems, devices, and methods unless otherwise indicated herein or otherwise clearly contradicted by context.

Groupings of alternative embodiments, elements, or steps of the systems, devices, and methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses an approximation that may vary, yet is capable of performing the desired operation or process discussed herein.

The terms “a,” “an,” “the” and similar referents used in the context of describing the systems, devices, and methods (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the systems, devices, and methods and does not pose a limitation on the scope of the systems, devices, and methods otherwise claimed. No language in the present specification should be construed as indicating any non-claimed element essential to the practice of the systems, devices, and methods.

All patents, patent publications, and other publications referenced and identified in the present specification are individually and expressly incorporated herein by reference in their entirety for the purpose of describing and disclosing, for example, the compositions and methodologies described in such publications that might be used in connection with the systems, devices, and methods. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A delivery storage system comprising:
a receptacle including a compartment for receiving a delivery and a barrier configured to move between an opened position for access to the compartment and a closed position to block access to the compartment;
a lock configured to lock the barrier in the closed position and configured to be unlocked to allow the barrier to move to the opened position; and
a controller configured to receive an unlock condition that is provided based on a software application used by a user, and configured to unlock the lock to allow the barrier to move to the opened position for allowing a deliverer to place the delivery in the compartment based on receipt of an unlock indicator, from the deliverer, that satisfies the unlock condition.

2. The delivery storage system of claim 1, wherein the receptacle includes a plurality of walls forming an outer surface of the receptacle.

3. The delivery storage system of claim 1, wherein the receptacle is configured to be free standing.

4. The delivery storage system of claim 1, wherein the barrier is configured to be exposed to outdoors, and the receptacle is joined with a structure.

5. The delivery storage system of claim 4, wherein the receptacle is configured to be accessible from within the structure.

6. The delivery storage system of claim 5, wherein the structure comprises a residential garage.

7. The delivery storage system of claim 4, wherein the receptacle includes an opening for access to the compartment from within the structure.

8. The delivery storage system of claim 1, wherein the receptacle is configured to be installed outdoors.

9. The delivery storage system of claim 1, wherein the receptacle is configured to be installed on a lawn, a patio, an outdoor walkway, or a porch of a residential property.

10. The delivery storage system of claim 1, wherein the barrier comprises one or more of a door, a gate, or a drawer face.

11. The delivery storage system of claim 1, wherein the receptacle includes a top surface and one or more side surfaces, and the barrier is positioned on the top surface.

12. The delivery storage system of claim 11, wherein the compartment is a first compartment, and the barrier is a first barrier, and the lock is a first lock, and the system further comprises:
a second compartment for receiving a delivery;
a second barrier positioned on the one or more side surfaces and configured to move between an opened position for access to the second compartment and a closed position to block access to the second compartment; and
a second lock configured to lock the second barrier in the closed position and configured to be unlocked to allow the second barrier to move to the opened position, and
wherein the controller is configured to receive an unlock condition that is provided based on the software application used by the user, and configured to unlock the second lock to allow the second barrier to move to the opened position for allowing a deliverer to place the delivery in the second compartment based on receipt of an unlock indicator, from the deliverer, that satisfies the unlock condition.

13. The delivery storage system of claim 1, further comprising one or more of a scanner, a keypad, a touch screen, a sensor, a camera, or a wireless communication device, for receiving the unlock indicator.

14. The delivery storage system of claim 1, wherein the unlock condition comprises one or more of a code, a symbol, a physical characteristic, or a proximity.

15. The delivery storage system of claim 1, wherein the delivery is requested by the user with the software application.

16. A method comprising:
providing a receptacle on a residential property, the receptacle including a compartment for receiving a delivery and a barrier configured to move between an opened position for access to the compartment and a closed position to block access to the compartment;
providing a lock configured to lock the barrier in the closed position and configured to be unlocked to allow the barrier to move to the opened position; and
providing a controller configured to receive an unlock condition that is provided based on a software application used by a user, and configured to unlock the lock to allow the barrier to move to the opened position for allowing a deliverer to place the delivery in the compartment based on receipt of an unlock indicator, from the deliverer, that satisfies the unlock condition.

17. The method of claim 16, wherein the receptacle is positioned within a residential structure.

18. The method of claim 17, wherein the receptacle is configured to be accessible from within the residential structure.

19. A system comprising:
a server configured to:
determine an unlock condition for a receptacle that is to receive a delivery for a user, the receptacle including a compartment for receiving the delivery and a barrier configured to move between an opened position for access to the compartment and a closed position to block access to the compartment and a lock configured to lock the barrier in the closed position and configured to be unlocked to allow the barrier to move to the opened position; and
provide the unlock condition to a controller of the receptacle, the controller configured to unlock the lock to allow the barrier to move to the opened position for allowing a deliverer to place the delivery in the compartment based on receipt of an unlock indicator, from the deliverer, that satisfies the unlock condition.

20. The method of claim 19, wherein the receptacle is configured to be accessible from within a residential structure.
